(19) United States
(12) Patent Application Publication
(10) Pub. No.: US 2020/0147553 A1
(43) Pub. Date: May 14, 2020

(54) METHOD FOR ELECTROCHEMICAL SEPARATION AND REGENERATION OF FORWARD OSMOSIS DRAW SOLUTION

(71) Applicant: Patrick Ismail James, Madison, WI (US)

(72) Inventor: Patrick Ismail James, Madison, WI (US)

(21) Appl. No.: 16/677,189

(22) Filed: Nov. 7, 2019

Related U.S. Application Data
(60) Provisional application No. 62/757,960, filed on Nov. 9, 2018.

(51) Int. Cl. B01D 61/58; B01D 61/00; B01D 61/02; B01D 61/08; B01D 61/56; C02F 1/44; C02F 1/469

(52) U.S. Cl. CPC B01D 61/58; B01D 61/005; B01D 61/025; C02F 1/4698; B01D 61/56; C02F 1/445; C02F 1/441; B01D 61/08

(57) ABSTRACT

A device for controlling acidity of electrolytes and the oxidation states or concentrations of selected constituents for treatment of liquid media using electricity for electrochemical separation and regeneration of forward osmosis draw solutions includes a FO unit arranged for osmotic solvent separation from a feed water stream, and an electrochemical solvent separation and draw solution regeneration unit incorporating an electrochemical cell, arranged to use diluted draw solutions to generate a concentrated draw solution, a TPW stream and an osmotic agent. The concentrated draw solution may be arranged to reenter the forward osmosis unit.

### CROSS REFERENCE TO RELATED APPLICATIONS

This application is related to and claims benefits of U.S. provisional patent application Ser. No. 62/757,960 entitled “METHOD FOR ELECTROCHEMICAL SEPARATION AND REGENERATION OF FORWARD OSMOSIS DRAW SOLUTION” filed Nov. 9, 2018. This application is also related to and claims benefits of co-owned U.S. patent application Ser. No. 14/737,827 entitled “METHOD FOR ELECTROCHEMICAL MODIFICATION OF LIQUID STREAM CHARACTERISTICS” (resulting in the U.S. Pat. No. 9,371,592); Ser. No. 13/926,291, entitled “APPARATUS AND METHOD FOR ADVANCED ELECTROCHEMICAL MODIFICATION OF LIQUIDS” (resulting in the U.S. Pat. No. 9,605,353); Ser. No. 13/621,349, entitled “APPARATUS AND METHOD FOR ELECTROCHEMICAL MODIFICATION OF LIQUIDS” (resulting in the U.S. Pat. No. 9,011,669); Ser. No. 13/117,769, entitled “APPARATUS AND METHOD FOR ELECTROCHEMICAL MODIFICATION OF CONCENTRATIONS OF LIQUID STREAMS” (resulting in the U.S. Pat. No. 8,545,692); Ser. No. 13/251,646, entitled “APPARATUS FOR ELECTROCHEMICAL MODIFICATION OF LIQUID STREAMS” (resulting in the U.S. Pat. No. 8,409,408); Ser. No. 13/020,447 entitled “A METHOD FOR ELECTROCHEMICAL MODIFICATION OF LIQUID STREAMS” (resulting in the U.S. Pat. No. 8,262,892); and Ser. No. 11/623,658 entitled “APPARATUS AND METHOD FOR ELECTROCHEMICAL MODIFICATION OF LIQUID STREAMS” (resulting in the U.S. Pat. No. 7,967,967); and the provisional U.S. patent application No. 62/482,274 entitled “METHOD FOR COMBINED ELECTROCHEMICAL MODIFICATION OF SELECTED LIQUID STREAM CHARACTERISTICS” and filed on Apr. 6, 2017, all of which (the applications and the resulting patents) are incorporated herein by reference in respective entireties.

### FIELD OF THE INVENTION

The invention relates to low energy water treatment methods involving well-known Forward Osmosis (FO), also known to the practitioners as Direct Osmoses DO (in contrast to the Reverse Osmosis process). More particularly, the current invention pertains to application of electrochemical technology to drive targeted redox reactions and directly control liquid stream chemistry to modify solutions used to effect FO. FO liquid solutions treatment process is based upon selective permeability properties of semipermeable membranes where selective transport of target species is usually driven predominantly by osmotic-pressure differences in solutions on opposite sides of a membrane separating the solutions. The fundamental FO process is that used widely in nature to transport species across many cell membranes and; for example, is how water is moved in plants from roots to leaves. FO has been recognized, in particular by the practitioners of water treatment art, as potentially advantageous over conventional treatment methods in a range of potential application spaces including, but not limited to, wastewater treatments, pretreatments and treatments of concentrated solution high ionic strength liquid streams, dialysis, fertigation, desalinization, generation of emergency water supplies, even potentially renewable energy generation, and others.

Generally, FO is a solvent separation and extraction process promoted by differences in osmotic pressures across semi-permeable membranes separating two or more solutions. Driven by such differences, solvents diffuse across the membrane from a volume of solution with lower osmotic pressures contacting one surface of the membrane into the volume of a solution having higher osmotic pressure contacting the opposite surface of the membrane without the necessity to apply fluid pressures or any alternative driving force. In this manner, a higher solute concentration “draw solution” effectively draws solvent from the stream being treated via a spontaneous low energy process. The draw solution is created by the incorporation of one or more Osmotic Agents (OA) into the desired solvent. The osmotic agents mingle with the solvent and increase bulk solution entropy and can be individual or combinations of dissolved substances or even very small particles. Solvent transferred into the used draw solution dilutes the draw solution and can be recovered and separated from the osmotic agent by a subsequent step utilizing a number of means to create a modified solvent product stream and a regenerated higher concentration draw stream. The regenerated draw stream may then be reused to again drive the spontaneous FO solvent extraction from the treated stream and thereby repeat the FO treatment cycle. The extracted solvent separation and draw solution regeneration step is thus central to practical application of FO treatment by enabling draw solution to recycle and consequently represents a key area for improvement towards FO utilization.

### BACKGROUND OF THE INVENTION

Solvent and solute separation from solutions or mixtures is a fundamental common problem affecting materials handling and management across a wide range of industries and application spaces. Water, with its plentiful and widespread global distribution, versatile chemistry, and ubiquitous use is the predominant solvent of interest. That said, while this discussion will focus on situations where water is the solvent for simplicity and clarity, the present invention is considered in the general sense and it is noted that the concepts and methods described can be applied to broad range of combinations of solvents, solutes, and is thus not restricted to the aqueous examples noted.

Water is a major resource and the combination of its intense use in industrialized society and the growing competition for it as a result of global population growth and modernization of major world populations has led it to be called the “oil of the 21^{st} century”. As a result, many long-established methods for separating solutes and water have been developed and continue to evolve to separate, clean, and reclaim water.

Examples of economically relevant solvent separation and cleaning methods generally fall into the basic categories of evaporation, precipitation, filtration, absorption and adsorption techniques. Developments in membrane technologies during recent decades have advanced filtration so that now commercial ultra, nano, and Reverse-Osmosis (RO) filtration are mature and widely used commercially available treatment options for separating solution components down to the microscopic and even chemical species level. While filtration approaches typically use fewer amounts of chemicals and less energy that evaporation or precipitation approaches, conventional filtration methods still rely on fluid pressure to drive the process and consequently remain moderately energy intensive.

Forward Osmosis (FO); by circumventing the conventional filtration need for fluid pressure to drive the target filtration, may be considered as innovative and exciting but represents a substantially underdeveloped and commercially emerging treatment which, nevertheless, holds great promises for improved low-energy solute and solvent separation and recovery. The process utilizes membranes similar to those of conventional Reverse Osmosis (RO) filtration but capitalizes on entropy driven diffusion to achieve the target solute/solvent separation. This inherently can make the resultant solvent/solute separation achieved much less energy intensive that conventional filtration. The process also tends to be less prone to fouling than fluid pressure driven processes. The process is described in more detail below.

In the conventional cases of major FO applications, predominantly water (as the solvent of interest) diffuses from lower osmotic pressures aqueous solutions (feed solutions) to higher osmotic pressures (draw solutions), while a separator membrane(s), chosen for inherent semi-permeability properties, substantially precludes transport in both directions of dissolved species between the draw and the feed solutions. The solvent (e.g. water) may transport across the membrane until osmotic pressure equilibrium is reached and a common osmotic pressure in both the feed and the draw solutions results. Consequently, a more diluted draw solution and a more concentrated feed solution is generated by the FO process; i.e. effective potentially useful transfer of solvent into the draw solution is achieved. With an exception where there may be direct use of the resulting (diluted) draw solution, for more general utilization a subsequent treatment step is usually required (e.g. RO) to separate and recover the transported solvent from the diluted used draw solution and to regenerate the concentrated refreshed draw solution.

One significant limitation for commercial. FO applications may be associated with the draw solution recycle steps, required for solvents separations and regeneration of the fresh draw solutions from the used/spent draw solutions. Such recycling steps of prior art may add significant complexity and energy inefficiency to the overall FO process because it usually relies on the prior art approaches. Commonly, this step may incorporate conventional RO-based filtrations to separate the water from the used draw solution with the RO reject (concentrate) being reused as the fresh draw solution. Other conventional, water separation approaches may be utilized, and more exotic approaches, such as osmotic agent thermal decomposition or magnetic separation, have also been considered but have yet to establish appreciable utility. The current invention provides an optimizable and versatile new (low-energy consumption) processing approach amenable to a range of draw solution functionalities targeted to better address the draw solution recycling step. Additionally, the current invention may enable the use of more concentrated draw solutions than amenable to RO, and thereby open avenues to new applications not currently available to conventional two-step FO/RO combined systems.

As the processes and devices in accordance with the current invention may augment the general FO concept, the new inventive steps may be employed to perform or mitigate a range of economically relevant treatments amenable to FO. In general, the new concepts may be applicable in applications where FO may be applied alone or in combination with other treatments.

More particularly, exemplary applications enumerated in Table 1 indicate some nonexclusive impact areas identified in an analysis performed recently by the U.S Department of the Interior, Bureau of Reclamation Research and Development Office (US Department of The Interior: Final Report ST-2015-7911-01, J. Korak and M. Arias-Paic “Forward Osmosis Evaluation and Applications For Reclamation”).

Additional uses may include examples like, but not limited to, enhanced dewatering of high Total Dissolved Solids (TDS) wastewater (e.g. mine leaching, process, bleed, or draindown solutions), and power generation based upon regeneration of a spent feedstock from electrochemical devices (e.g. flow-batteries utilizing electrochemical concentration cells) or alternatively osmotic pressure power production such as outlined decades ago by Loeb and Jellinek (Loeb S., “Osmotic Power Plants”, Science, 189 (1974), Jellinek H. H. G., Osmotic Work I. “Energy Production From Osmosis On Fresh Water/Saline Water, Systems”, Kagaku Kojo 19 (1975)). Furthermore, the innovations pertinent to the current invention may significantly contribute to enhanced oil recovery processes. In different embodiments, the current invention may be also applied to drug delivery via electrical draw solution concentration control for osmotic pump actuation.

TABLE 1
Summary of FO Applications and Outlook For Future Use

| | | | Of Use Compared | |
|---|---|---|---|---|
| | | | To Other Technologies | |
| | Maturity Of | Potential For | | At Full |
| Application | Technology | Improvement | Currently | Maturity |
| Fertigation | Bench Scale | Low | Low | Low |
| | Tests Only | | | |
| Emergency | Commercially | Low | Moderate | Low |
| Water | Available | | | |
| Supply | | | | |
| Highly | Bench And | High | Moderate | High |
| Saline | Pilot Scale | | | |
| Wastes | Tests | | | |
| Direct | Bench Scale | Moderate | Low | Moderate |
| Wastewater | Tests | | | |
| Treatment | | | | |
| Osmotic Dilution | Bench And | Moderate | Moderate | Moderate |
| Of Saline Water | Pilot Scale | | | |
| Using Impaired | | | | |
| Water | | | | |
| Conventional | Bench | Moderate | Low | Low |
| Desalination | Scale | | | |
| Pre-Treatment | | | | |

FO is conventionally most applicable for scenarios of water recovery from: 1) Highly fouling and scaling brines, 2) High TDS or saline solutions, and, 3) Applications where multiple separation barriers are required to achieve product water purity goals.

In particular, applications for enhanced capture of water and/or mined metals (e.g. copper, zinc, nickel, etc. processing) from streams frequently include modification of mining streams (raffinate, wastewater, draindown, processing bleeds, Pregnant Leach Solution (PLS), and other stream's chemistry to improve mining productivity. The current invention here affords a new ability to effect and control such modifications by leveraging electrochemistry driven by an electrolytic cell to improve target stream processing efficiency and/or target operations. Other examples of water removal from high TDS streams may include: treatment of produced water from natural, gas extraction, landfill, leachate, anaerobic digesters effluents, and brines such as reject solution from desalination operations or other brine generating processes.

In addition to providing an alternative for conventional RO use in the draw solution recycle step, the versatility of the current invention may also provide more economical alternative to thermolytic draw solution recycle, well known to the practitioners. In thermolytic draw solution recycle schemes (such as put forth by McCutcheon et al., McCutcheon U. R., McGinnis R. L., Elimelech M., “A Novel Ammonia-Carbon Dioxide Forward (Direct) Osmosis Desalination Process”, Desalination 174 (2005)) thermolytic salts, which decompose into volatile gases and which leave the solution upon heating, such as CO₂ or NH₃, are used as the osmotic agent(s) in their dissolved form. Heating converts them to their gaseous form and removes them from the used draw solution. A subsequent step or steps employing conventional water separation methodology may be used to remove the product water (solvent) and generate the cooled and degassed residual used draw stream. The released gases may be captured and then re-dissolved into the cool draw solution to regenerate the refreshed and recycled draw stream. The thermolytic approach of prior art does allow the generation of higher osmotic pressure draw streams than amenable to RO, but does require a moderately elevated temperature heat source, making the economics dependent on the cost of such heat supply to the process. The approach also adds the complexity of at least one additional processing unit arranged to perform the above process.

The current invention may be used to accomplish essentially the same net draw solution osmotic agent separation and regeneration more directly and in a single step through a different process. As an example, a draw solution incorporating the NH₄CO₃ could again be used. Rather than employ thermolytic decomposition as noted above, here electrolytic solution pH manipulation may be used to convert the dissolved species forms (NH₄⁺ and CO⁻²) into their gaseous forms (NH₃ and CO₂) respectively through their pH equilibria. When passed through the cathodic chamber of the operating split compartment electrolytic cell separated by an anion selective separator membrane, the solution pH could be raised to drive the ammonium from solution as ammonia while the carbonate anions simultaneously are transported to the anodic chamber to maintain charge balance where they may accumulate to a greater concentration than they originally were in the catholyte. Ammonia gas released from the catholyte can be fed into the anolyte solution to combine with acid generated at the anode to regenerate the ammonium and maintain the carbonate in its soluble form (i.e. hinder carbonic acid decomposition in the anolyte) to regenerate the cleaned and concentrated draw solution. The process may be also run in reverse with the use of a cation selective separator membrane where the used draw solution is fed into the anolyte chamber and regenerated in the cathode chamber. Other instantiations using combinations of these two options and different draw stream chemistries may also be possible and desirable depending on the specific treated stream and draw stream chemistries utilized.

Similar treatment schemes using electrolytic manipulation of solution pH or targeted osmotic agent oxidation states might also be used to achieve draw solution osmotic agent removal and regeneration (recycle) by control of species solubility or other relevant chemical attributes. For example, metal sulfide compounds might be used as osmotic agents and cycled into and out of solubility through adjustment of the draw solution pH and/or the redox state(s) of components of the osmotic agent.

The solution modification capabilities enabled by several aspects of the current invention may be adapted to address at least some of the above considerations. In general, solute separation or concentration methods frequently further require acidity control and pH manipulation (such as adjusting pH to manipulate solute solubility or stability) or—manipulation of target species redox states to improve selected aspects of the target stream processing. Classic examples may incorporate but are not limited to conversions of Fe⁺³ to F⁺², Fe⁺² to Fe⁺³, Fe⁺² to Fe(s), Fe⁺³ to Fe(s), Fe(s) to Fe⁺², Fe(s) to F⁺³ or Cu⁺¹ to Cu⁺², Cu⁺² to Cu⁺¹, Cu⁺¹ to Cu(s), Cu⁺² to Cu(s), Cu(s) to Cu⁺¹, Cu(s) to C⁺² or Zn⁺² to Zn(s), and Zn(s) to Zn⁺² as at least part of the osmotic agent in the draw solution used in conjunction with appropriate anions such as but not limited to common anions like OH⁻, SO₄⁻², HSO₄⁻, ClO₄⁻, NO₃⁻, C₂H₃O₂⁻, Cl⁻, Br⁻, I⁻, F⁻, PO₄⁻³, and others.

Generally, electrochemical apparatus and methods in accordance to the current inventions utilize electricity as convenient, easily-transportable, and efficiently controllable “universal electrochemical agent” used in the desirable electrochemical reactions (in addition to conventional usage of electricity predominantly as energy supply). Furthermore, in contrast to standard precipitation or chemical treatments requiring deliveries of significant amounts of chemicals acids, alkalis, and/or salts or and filtration processes requiring fluid pressure derived from mechanical means, various embodiments of the current inventions enable reduction of disposable byproducts (e.g. by in-situ recycling and regeneration of desirable components), and flexibility of process optimization achievable, for example, by active real time (continuous or batch-to-batch) controlling of concentrations, flows, efficiencies, and reaction rates of redox reactions in the targeted electrochemical cells.

### SUMMARY OF THE INVENTION

A method in accordance with the current invention includes use of electrolytic apparatus consisting of at least one split-compartment electrolytic cell having at least one electrode compartment structured to contain a liquid electrolyte. The at least one electrolytic cell is structured to support redox reactions and to generate liquids usable for creating and maintaining particular concentrations of selected targeted ions such as cations, Hydrogen ions, hydroxyl ions, and other species conducive for desired modification of the FO draw solution. Targeted solution modification could include the removal, destruction, conversion, creation, concentration and/or transport of targeted materials in internal or separate reactors through a variety of mechanisms driven by the electrolytic cell to achieve desired component separation and/or regeneration for FO draw solution recycle.

### BRIEF DESCRIPTION OF THE DRAWINGS

The above and other embodiments, features, and aspects of the present invention are considered in more detail in relation to the following description of embodiments shown in the accompanying drawings, in which:

FIG. 1. is a schematic of one embodiment in accordance with prior art.

FIG. 2. is a schematic illustration of one embodiment of the current invention.

FIG. 3. is another schematic illustration of one embodiment of the current invention.

FIG. 4. is another schematic illustration of one embodiment of the current invention.

FIG. 5. is another schematic illustration of one embodiment of the current invention.

FIG. 6. is another schematic illustration of one embodiment of the current invention.

FIG. 7. is another schematic illustration of one embodiment of the current invention.

FIG. 8. is another schematic illustration of one embodiment of the current invention.

FIG. 9. is another schematic illustration of one embodiment of the current invention.

FIG. 10. is another schematic illustration of one embodiment of the current invention.

FIG. 11. is another schematic illustration of one embodiment of the current invention.

FIG. 12. is another schematic illustration of one embodiment of the current invention.

FIG. 13. is another schematic illustration of one embodiment of the current invention.

FIG. 14. is another schematic illustration of one embodiment of the current invention.

FIG. 15. is another schematic illustration of some features of the current invention.

FIG. 16. is another schematic illustration of one embodiment of the current invention.

FIG. 17. is another schematic illustration of one embodiment of the current invention.

FIG. 18. is another schematic illustration of one embodiment of the current invention.

### DETAILED DESCRIPTION OF THE INVENTION

The current invention summarized above may be better understood by referring to the following description, which should be read in conjunction with the accompanying drawings. This description of an embodiment, set out below to enable one to build and use an implementation of the invention, is not intended to limit the invention, but to serve as a particular example thereof. Those skilled in the art should appreciate that they may readily use the conception and specific embodiments disclosed as a basis for modifying or designing other methods and systems for carrying out the same purposes of the present invention. Those skilled in the art should also realize that such equivalent assemblies do not depart from the spirit and scope of the invention in its broadest form.

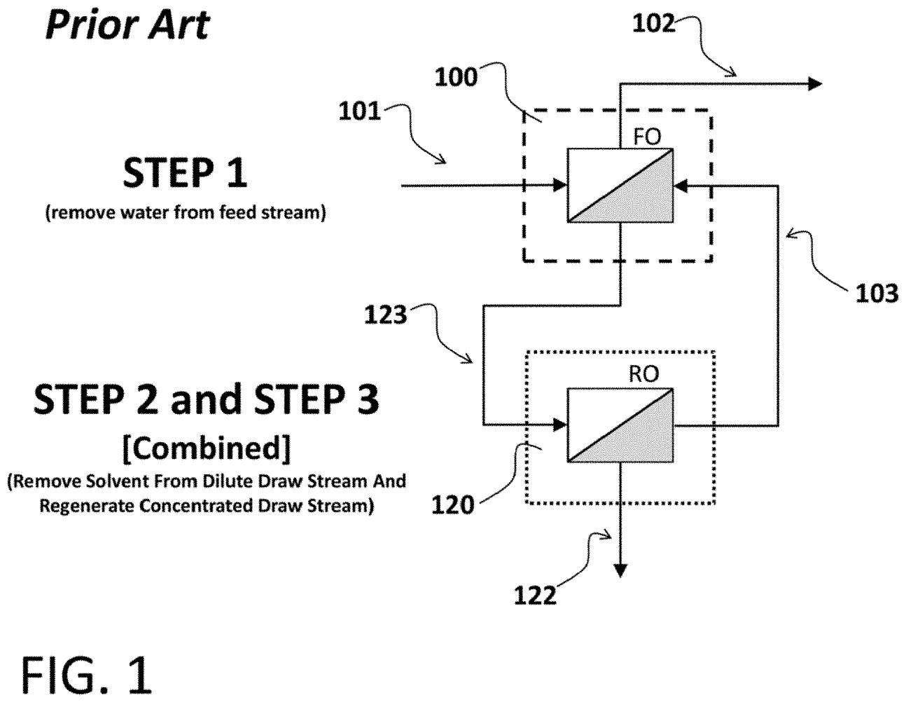

It may be generally recognized that the operation of an FO based treatment system can employ elements for the FO solvent separation from the target stream step (e.g. STEP 1; FIG. 1), a solvent separation from the diluted used draw solution (STEP 2 in FIG. 1,), and often a draw solution regeneration step (STEP 3; FIG. 1 or may be combined in the STEP 2 as depicted in FIG. 1), and other potential processing steps which can occur in many forms. For conceptual clarity, discussion here will focus on embodiments centered on a conventional prior art example, such as illustrated in FIG. 1, having understanding that embodiments utilizing additional forms for noted elements merely represent obvious extensions of the teaching herein.

One such relevant class of integrated FO systems may be represented by the specific example of a two-step treatment scheme utilizing FO for the STEP 1 and RO for the STEP 2. Such classes may represent a subset of integrated two-step FO distinguishable by the choice of subsequent treatment X (X=a general solvent separation from used draw solution and draw solution regeneration process). The STEP 1 of the illustrated embodiment of the two-step integrated FO and RO treatment of prior art provides a single (nonexclusive) example of a subsystem suitable for use in the current method for illustrative purposes. Such subsystems may include the STEP 1 in the form of Forward Osmosis (unit 100 in FIG. 1) into which a feed water stream 101 is fed for treatment along with a separate concentrated draw solution stream 103. Solvents (e.g. water) may be separated by the FO unit 100 and passed into the distinct draw stream, diluting it into used diluted draw solution 123 which exits the FO unit 100 while a distinct treated FO reject solution stream 102 also exits the FO unit. The used diluted draw solution 123 may be, for the STEP 2, transferred to a RO solvent separation and draw solution regeneration unit 120. The RO unit separates solvent (water) from the used diluted draw solution 123, creating a distinct Treatment Product Water (TPW) 122. The remainder of the RO treated stream of the used diluted draw solution 123 may be concentrated in osmotic agent present in the used diluted draw solution 123 stream, and may exit the RO unit 120 as a reject or regenerated in a concentrated draw solution 103, which may be returned to the FO unit 100 of the STEP 1 to complete the recycle of the draw solution as part of the integrated two-step FO water treatment.

In instantiations for effecting the current invention devices may include embodiments where the RO element of the STEP 2 of FIG. 1 stands replaced with one or more electrochemical units comprising of one or more electrolytic cells (e.g. of the split-chamber variety) utilizing a selective or non-selective permeability ion conductive separating membrane between the anode and cathode chambers. Herein, the electrodes may be traditional static electrodes, or dynamic cathode/static anode, dynamic anode/static cathode, or dynamic bipolar (dynamic anode and cathode) variants. The present invention utilizes electricity supplied from an external source into one or more Electrochemical Cells or Electrolytic Cells (EC for the single cell case and ECn where n=1, 2, N for the N cell case) to directly separate and regenerate the diluted osmotic agent draw solution into product water and regenerated draw solution containing concentrated osmotic agent to effect the STEP 2 for FO treatment. The electrochemical units may be utilized separately to achieve the STEP 2 or, in conjunction with conventional draw solution separating and/or regenerating methods and apparatus, to create the integrated target treatment device for accomplishing the methods of the current invention.

It may be generally recognized that operation of electrochemical cells is based on redox reactions and can employ cells which can occur in many forms. In general, the class of split compartment cells (SCC) (in their multitude of forms) can provide examples of suitable apparatus as arranged to accomplish the current method disclosed herein. One such relevant example typical of the class of Moving Bed Electrode (MBE) cells may be represented by the specific example from the subset of Spouted Bed Electrode (SBE) cells as disclosed in the above incorporated (by the reference in the opening paragraph of the current Application) U.S. Pat. No. 7,967,967 ('967) and schematically illustrated in the FIG. 1 of the '967. The one embodiment of an SBE cell of prior art provides a single (nonexclusive) example of a device suitable for use in the current method for illustrative purposes and may include of one or more anodes 10 coupled to one or more high surface area cathodes 20, here in the form of a spouted moving particulates bed, separated by a distance. Catholyte flow 30 of liquid electrolyte catholyte 24, driven by an external catholyte pumping station 40, is directed through the high surface cathode 20 to achieve vigorous convection in the particulates bed to facilitate a high degree of electrode utilization. Unidirectional current is fed into the cell via anode current feed 50(+) and out via cathode current feeder device 90 and cathode current feed 50(−). The cell. illustrated in the FIG. 1. is shown in a simple double chamber planar configuration comprising cathode cell chamber 60 and anode cell chamber 70 (generally containing electrolytes, catholyte 24 and anolyte 14 respectively) each pair of which is separated by a separator allowing ionic conduction (a porous or selective membrane for example) 80 which directs the bulk flows of electrolytes (catholyte 24 and anolyte 14) while maintaining intimate electrochemical contact between the separated cathode 20 and anode 10 via ionic conduction. The authors note that other cell configurations (stacked, cylindrical, etc.) could readily also be employed and that cells employing multiple and additional chambers may be of the same or different configurations and employ the same or different cathodes 20, anodes 10, and separators 80 as desired by a specific situation. Depending upon the state of control valve system 85 the cell can operate in a batch mode processing the fluid contained in the reservoir 97, or in a flow-through mode modifying liquid streams delivered by external pipelines 95.

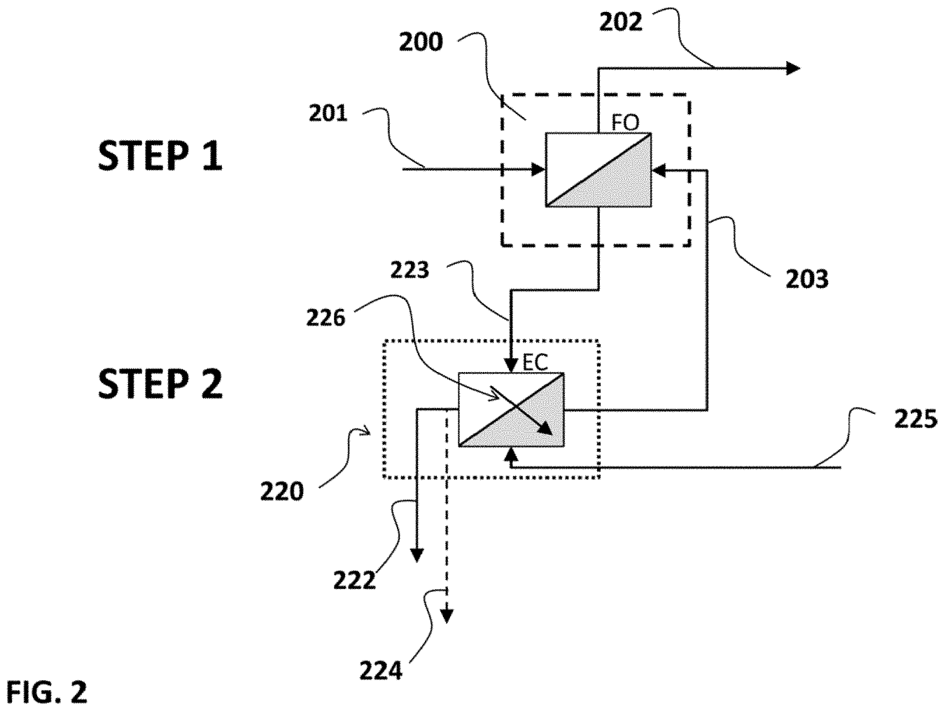

It is well-understood that, as recited in the '967, the operation of a SCC cell may be based in redox chemical reactions generally resulting in changes of pH values of the anolyte 34 from relatively high input (beginning value in the batch operation embodiments) value to relatively lower output value (ending value in the batch operation embodiments), while in opposition, the catholyte 24 may be reacted from respective states of relatively low pH into states of relatively high pH values. It may be noted that such acidity changes may be controlled by the specific design and components of the apparatus, control of the fluid flows and electrical discharge parameters. It may be additionally noted that, by arranging and controlling of transport (motions and reactions) of charged species (e.g. ions and electrons) through any simple or composite (multi-chamber) cell one can change oxidation states and/or pH of the electrolytes (and other compounds) in the pertinent chambers of the particular electrolytic cell. Thus, in the simple example in FIG. 2, one may note that the electrochemical redox process generally increase acidity (reduce pH) of the anolyte 14, while simultaneously increasing alkalinity (increasing pH) of the catholyte 24.

For example, at the cathode 20 the pH might be raised by proton reduction and hydrogen formation (typical for water splitting at elevated pH or acid neutralization at low pH Eqs. (1)-(3)). Alternatively, oxygen reduction might be targeted to generate alkaline hydroxide or even a potential reactant like hydrogen peroxide (which can then be used as an oxidant or a reductant depending on the detailed chemistry created).

| | CONDITIONS |
|---|---|
| 2H⁺ + 2e⁻ → H₂ (g) | (1) ACID |
| H⁺ + H₂O + 2e⁻ → H₂ (g) + OH⁻ | (2) Neutral/Alkaline |
| O₂ + 2H₂O + 4e⁻ → 4OH⁻ | (3) Neutral/Alkaline |

The devices and methods of several embodiments of the current invention may be understood using the above concepts of electrochemical controlling of the acidity of pertinent electrolytes and the oxidation states of selected constituents for treatment of preexisting liquid media and/or ad hoc prepared solutions using electricity. More particularly, in some embodiments one or more electrochemical cells may be used singularly or in combinations to separately, simultaneously, or combinations thereof, control pH values of the electrolytes, generate particular oxidation states of the constituents, and act as a reactor for desired chemical reactions (e.g. precipitation of desired metal hydroxides).

One additional class of embodiments of processing devices for the present invention in accordance with the above treatment scheme has been illustrated in FIG. 2 of the current Application. The devices of the illustrated embodiment have been arranged with the specific example of a two-step treatment scheme utilizing FO for the STEP 1 and electrochemical cells EC for the STEP 2 as illustrated in FIG. 2. This one embodiment of a two-step integrated FO and EC treatment of the present invention provides a single nonexclusive example of an additional device suitable for use in the current method for illustrative purposes and may include for the STEP 1 a FO unit 200 into which a feed water stream 201 is fed for treatment along with a separate concentrated draw solution stream 203. Solvent (water) is separated by the FO unit and passed into the distinct draw stream, diluting it into used diluted draw solution 223 which exits the FO unit 200 while the distinct treated FO reject solution stream 202 also exits the FO unit. The used diluted draw solution 223 is, for the STEP 2, transferred to an EC solvent separation and draw solution regeneration unit 220. The EC unit 220 separates solvent (water) from the used diluted draw solution 223, creating a distinct TPW stream 222 and a distinct electrochemically separated osmotic agent PART A 224. A distinct stream of feedstock 225 for generation of osmotic agent PART A or replenishment of osmotic agent (both PARTS A and B) is introduced into the other half-cell of the EC unit 220, while electrochemically separated osmotic agent PART B 226 is transferred from the diluted draw solution chamber to the electrochemically generated concentrated draw solution chamber across the chamber separation membrane. Streams 225 and 226 combine to regenerate the electrochemically generated concentrated draw solution 203 which is returned to the FO unit of the STEP 1 to complete the recycle of the draw solution as part of the integrated two-step FO water treatment.

A multitude of potential redox based chemistries may be structured as separate embodiments or in combinations to achieve targeted treatment. A minimum of three classes of embodiments are identified. In a first class of embodiments, the OA PART A (the cation portion of an OA comprised of a cation and anion combination) is electrochemically separated from the draw solution while the OA PART B (the anion portion) gets transferred from one chamber of the electrolytic cell to the complementary half-cell chamber through the separator membrane during the electrochemical reaction. Several sub-classes within this class of embodiments (and by extension respectively within each of the noted three classes) are identified. The electrochemical separation (here of OA component A) can be effected directly via a redox reaction driven at the corresponding electrode or indirectly by another product electrochemically generated directly at the corresponding electrode. Further the species transformation leading to the electrochemical separation may or may not involve a phase change. Nonexclusive examples may include:

### Direct Electrochemical Transformation:

Phase Change: Plating, Dissolution, Decomposition, Precipitation, Gas Formation
No Phase Change: Oxidation State Change (Fe⁺¹/Fe⁺² for example), Phase Separation

### Indirect Electrochemical Transformation:

Phase Change: Precipitation, Dissolution, Gas Formation
No Phase Change: Neutralization, Complexation, Phase Separation
   The target transformations may be driven at either the anode or cathode as required for the specific chemistries being used and separator membranes may be of non-selective, cation selective, or anion selective permselectivities as appropriate for specific instantiation chemistries. In a second class of embodiments, the OA PART B (the OA anion portion) is electrochemically separated from the draw solution while the OA PART A (the cation portion) gets transferred from one chamber of the electrolytic cell to the complementary half-cell chamber during the electrochemical reaction. In a third class of embodiments, both the OA PART A (the OA cation portion) and the OA PART B (the anion portion) are electrochemical separated (in many cases one component [either OA PART A or PART B] may be transferred through the separator membrane to the complementary half-cell. portion of the split compartment cell to effect the target electrochemical separation while the other component gets electrochemically separated by reactions driven in the half-cell portion of the split compartment cell where the draw solution is fed in.

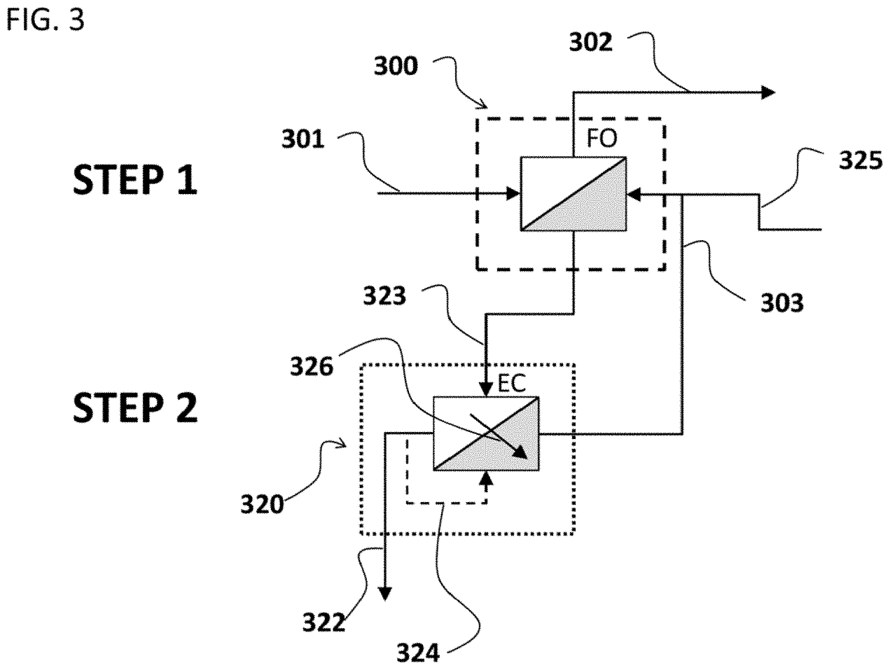

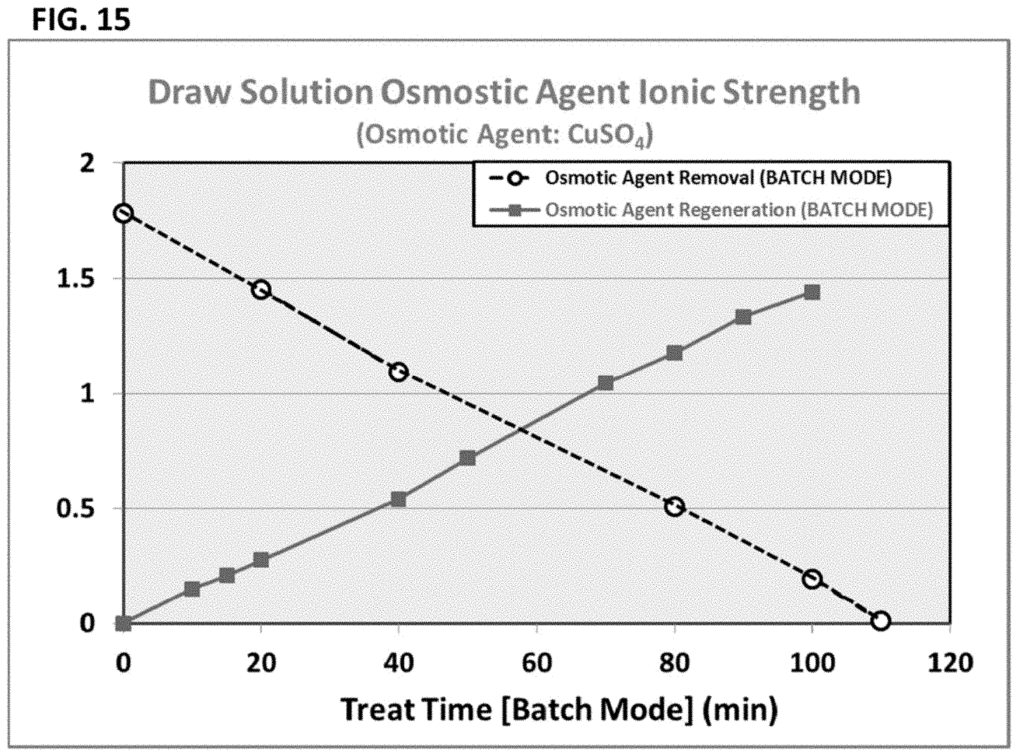

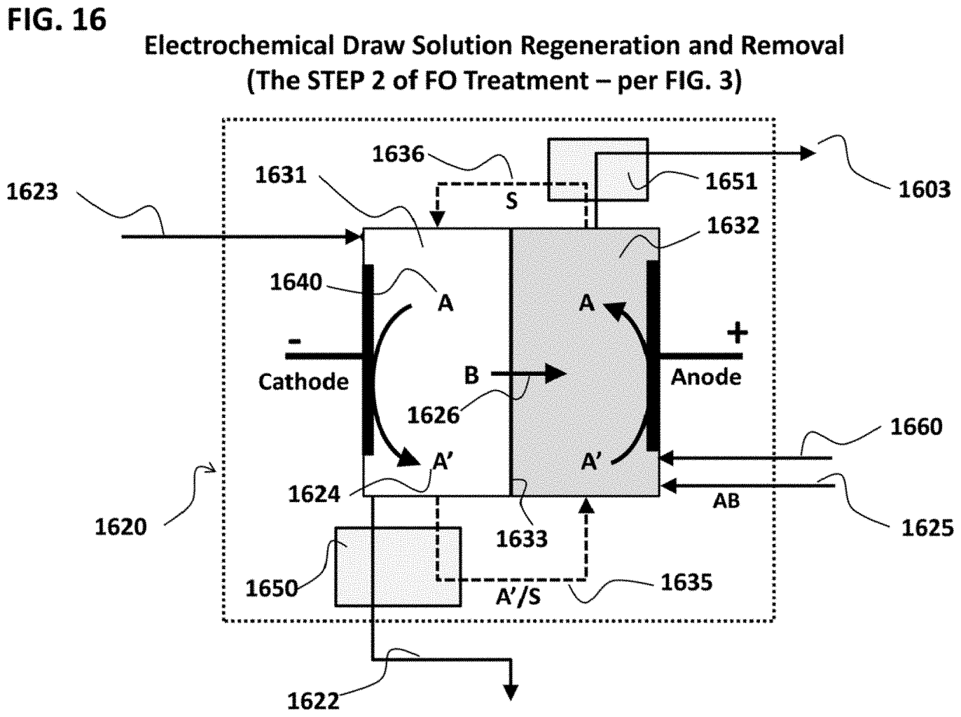

Three nonexclusive examples are described below to illustrate each of the classes of the embodiments noted. To better illustrate the specific example solution(s) transport and application are discussed in the context of the treatment arrangement seen in FIG. 3 as a nonexclusive framework for a applying a particular specific OA chemistry and representative results for the STEP 2 EC portion of the overall treatment of FIG. 3 are discussed in the context of FIG. 15. It is noted that the EC unit 320 for the STEP 2 of may represent the full range of static and dynamic electrolytic split chamber cells used individually or in combination. It is shown here as a single dynamic bipolar (dynamic cathode/dynamic anode) case for clarity. The details of the example electrochemical processing are discussed in the context of FIG. 16.

An example of the first class of embodiments is described (separation of OA PART A with transfer of OA PART B). In the present illustrative example, a solution of copper sulfate, CuSO₄, is considered as the AO for the draw solution and consists of select cation(s) PART A (here Cu⁺²) and select anion(s) PART B (here SO₄⁻²). This represents a single example of a class of embodiments targeting direct electrochemical elimination (plating, decomposition, etc.) of draw solution OA PART A and concurrent electrochemical separation/transfer of draw solution OA PART B. Fresh concentrated OA (CuSO₄) 303 (corresponds to 1603 in FIG. 16) may be generated and passed to the THE STEP 1 FO unit 300 where it extracts water from target feed stream 301 and gets returned to the STEP 2 EC solvent separation and draw solution regeneration unit 320 as used diluted draw solution 323 (corresponds to 1623 in FIG. 16).

In the more detailed view of the electrochemistry provided by FIG. 16, the diluted draw solution 1623 is fed into the cathode chamber 1631 of the split electrochemical cell comprising EC unit 1620 for the STEP 2 of the overall FO treatment. Here PART A (cupric ion, Cu⁺²) 1640 of the AO (CuSO₄) gets reduced to A′ product 1624 (here copper metal) and plated onto the dynamic cathode by reduction reaction (4).

CATHODE REDUCTION REACTION

Cu⁺²+2e⁻→Cu(s) (4)

ANODE OXIDATION REACTION

Cu(s)→Cu⁺²+2e⁻ (5)

The treated catholyte and plated material are passed to catholyte solid-liquid separator 1650 and separated into substantially distinct streams product solution 1622 containing residual AO after the EC treatment and the separated solid reduced form of OA PART A, A′ carried on the loaded dynamic electrode substrate A′/S 1635. The loaded dynamic electrode A′/S 1635 is passed to and fed into the anode chamber 1632 of the split compartment cell. Here the reduced form A′ of the OA PART A is oxidized back to form A at the anode and returns into solution by oxidation reaction (5). Concurrently to maintain charge balance AO PART B 1626 (here sulfate, SO₄⁻² or bisulfate, HSO₄⁻ or combinations thereof depending on pH conditions) transfers from the split cell cathode chamber 1631 to the anode chamber 1632 by passing through the membrane separator 1633 (here a permselective membrane supporting ion conduction and selective towards anion transport and retards transfer of cation OA PART A back into the catholyte by passage through the membrane) where it recombines with the regenerated OA PART A form A 1640 (here Cu⁺²) to recreate the cleaned and refreshed OA (CuSO₄). Through anolyte recirculation and control of makeup water 1660 addition, the anolyte solution product 1603 can be concentrated in the target OA (CuSO₄). Some makeup OA 1625 may also be fed into the anolyte to replenish any net loss of OA during this recycling process. The cleaned, refreshed draw solution concentrated 1603 in OA (CuSO₄) and the stripped dynamic electrode 1636 is passed to and fed into anolyte solid-liquid separator 1651 and separated into substantially distinct streams concentrated draw solution 1603 containing concentrated AO after the EC treatment and the separated solid stripped dynamic electrode substrate S 1636. The stripped dynamic electrode substrate S 1636 gets passed and returned to the cathode chamber of the split electrolytic cell for reloading with the reduced form A′ of OA PART A. The separated distinct concentrated draw solution 1603 gets returned to the FO unit of the STEP 1 to complete the recycle of the draw solution as part of the integrated two-step FO water treatment.

FIG. 15 shows some illustrative results obtained for the example OA chemistry of cupric sulfate (CuSO₄). Here the removal of the OA (CuSO₄) and regeneration of the OA (CuSO₄) are shown by plotting the ionic strength of the target solutions (which is proportional to the associated solution's component concentrations and respective osmotic pressure) as a function of time as the process is run in batch mode. In the context of FIG. 16, the osmotic agent removal line corresponds to the OA catholyte concentration of A 1640 if product solution 1622 was recirculated and returned as diluted draw solution 1623 (i.e. batch mode). In the context of FIG. 16, the osmotic agent regeneration line corresponds to the OA anolyte concentration of A 1640 if concentrated draw solution 1603 was recirculated and returned as “makeup” water 1660 (i.e. batch mode). It may be seen that essentially all of the OA is removed from the diluted draw solution 1623 and that concentrated OA is effectively regenerated in the concentrated draw solution 1603.

The preceding noted example may be applicable to a range of combinations of redox active metals and cations used with appropriate anions, including carbonate salts, hydroxyl complexes for transition metals, like (Fe—OH)⁺², [Fe—(OH)₂]⁺¹, and ammonia complexes like Cu(NH3)₄⁺² and its variants. Notable common AO examples include but are not limited to: Cu(NO₃)₂, Cu(ClO₄)₂, Fe(NO₃)₂, Fe(ClO₄)₂, FeSO₄, Fe(NO₃), Fe(ClO₄)₃, Fez(SO₄)₃Cu(NO₃), Cu(ClO₄), Zn(NO₃)₂, Zn(ClO₄)₂, ZnSO₄, and others.

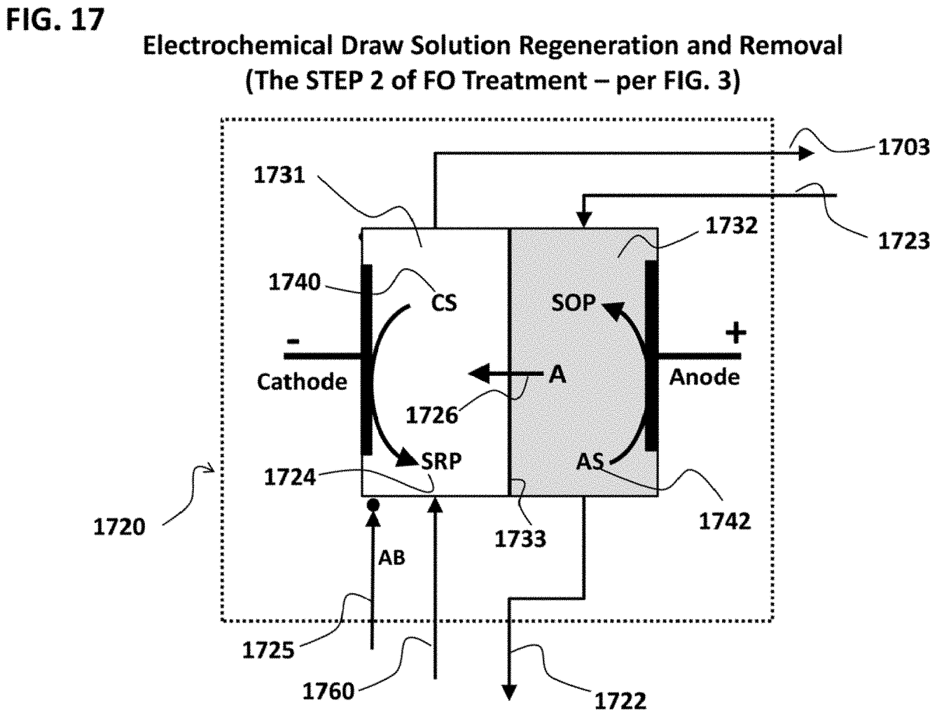

An example of the second class of embodiments is described (separation of OA PART B with transfer of OA PART A). In the present illustrative example, a solution of sodium hydroxide, NaOH, is considered as the AO for the draw solution and consists of select cation(s) PART A (here Na⁺) and select anion(s) PART B (here OH⁻). In the context of FIG. 3, fresh concentrated OA (NaOH) 303 (corresponds to 1703 in FIG. 17) may be generated and passed to the STEP 1 FO unit 300 where it extracts water from target feed stream 301 and gets returned to the STEP 2 EC solvent separation and draw solution regeneration unit 320 as used diluted draw solution 323 (corresponds to 1723 in FIG. 17).

In the more detailed view of the electrochemistry provided by FIG. 17 (here illustrating the process for a static cathode/static anode split compartment cell), the diluted draw solution 1723 is fed into the anode chamber 1732 of the split electrochemical cell comprising EC unit 1720 for the STEP 2 of the overall FO treatment. Here PART B (hydroxide ion, OH⁻) 1724 of the AO (NaOH) gets eliminated by neutralization via reaction (6) with anode solvent oxidation product SOP (protons, H⁺) generated by oxidation of anolyte solvent AS 1742 (water) by reaction (7) at the anode. Concurrently to maintain charge balance AO PART A 1726 (here sodium, Na⁺) transfers from the split cell anode chamber 1732 to the cathode chamber 1731 by passing through the membrane separator 1733 (here a permselective membrane supporting ion conduction and selective towards cation transport and retards transfer of catholyte solvent reduction product SRP 1724 back into the anolyte by passage through the membrane). Electrochemically cleaned anolyte of reduced OA concentration is passed out of the anode chamber and the draw solution regeneration and removal. unit 1720 as product water stream 1722. OA PART A 1726 passes to the catholyte chamber where it combines with the regenerated OA PART B solvent reduction product SRP 1724 (hydroxide, OH⁻) generated by reduction of catholyte solvent CS 1740 (water) by reaction (8) at the cathode to recreate the cleaned and refreshed OA (NaOH).

OSMOTIC AGENT PART B (OH⁻) NEUTRALIZATION REACTION

H⁺+OH⁻→H₂O(l) (6)

ANODE SOLVENT OXIDATION PRODUCT (H⁺) REACTION

H₂O(l)→4H⁺+O₂(g)+4e⁻ (7)

CATHODE SOLVENT REDUCTION PRODUCT (OH⁻) REACTION

H₂O(l)+2e⁻→2OH⁻+H₂(g) (8)

Through catholyte recirculation and control of makeup water 1760 addition, the anolyte solution product 1703 can be concentrated in the target OA (NaOH). Some makeup OA 1725 may also be fed into the catholyte to replenish any net loss of OA during this recycling process. The cleaned, refreshed draw solution 1703 concentrated in OA (NaOH) after the EC treatment gets returned to the FO unit of the STEP 1 to complete the recycle of the draw solution as part of the integrated two-step FO water treatment.

The preceding noted example may be applicable to a range of combinations of redox active metals and cations used with appropriate anions. Notable common AO examples include but are not limited to: KOH, LiOH, NH₄OH, Mg(OH)₂, and others.

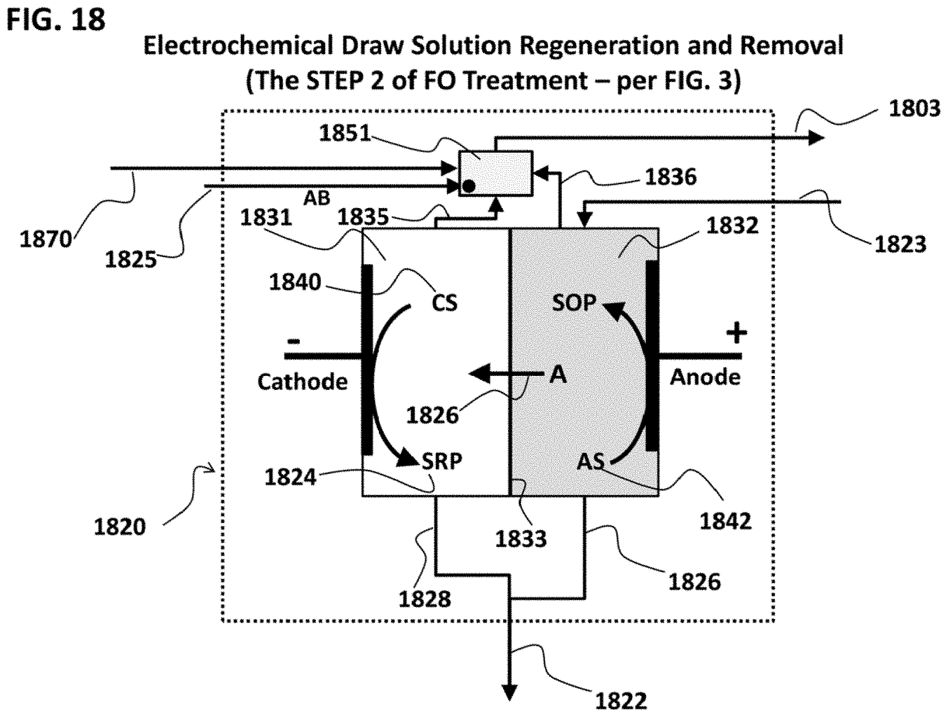

An example of the third class of embodiments is described (separation of OA PART A and separation of CA PART B). In the present illustrative example, a solution of ammonium carbonate, (NH₄)₂CO₃, is considered as the AO for the draw solution and consists of select cation(s) PART A (here NH₄⁺) and select anion(s) PART B (here CO₃⁻²). In the context of FIG. 3, fresh concentrated OA ((NH₄)₂CO₂) 303 (corresponds to 1803 in FIG. 18) may be generated and passed to the STEP 1 FO unit 300 where it extracts water from target feed stream 301 and gets returned to the STEP 2 EC solvent separation and draw solution regeneration unit 320 as used diluted draw solution 323 (corresponds to 1823 in FIG. 18).

In the more detailed view of the electrochemistry provided by FIG. 18 (here illustrating the process for a static cathode/static anode split compartment cell), the diluted draw solution 1823 is fed into the anode chamber 1832 of the split electrochemical cell comprising EC unit 1820 for the STEP 2 of the overall FO treatment. Here OA PART B (carbonate, CO₃⁻²) reacts (indirect transformation sub-class) with anolyte solvent oxidation product SOP (here protons, H⁺ generated by reaction (7)) by reaction (9) of anolyte solvent AS 1842 (water). This forms carbonic acid and separates carbon dioxide by reaction (10) in conjunction with the product carbon dioxide (CO₂) gas solubility. The outgassed product gas (CO₂) separates from the anolyte solvent AS 1842 and is removed from the anode chamber 1832 as stream 1836. The carbon dioxide (CO₂) 1836 is fed to reaction chamber 1851 where it is combined by reaction (12) with ammonia (NH₃) 1835 electrochemically separated from OA PART A in chamber 1831 and fed to the reaction chamber 1851 and makeup water 1870 to reform the cleaned and refreshed AO agent ([NH₄]₂CO₃) in a concentrated form which is then passed from the reaction chamber 1851 as the concentrated draw solution stream 1803 (It is noted that the recombination of the essential separated elements of OA components A and B in reaction chamber 1851 could also be performed within the electrochemical cell, such as in catholyte chamber 1831 for example). Concurrently to maintain charge balance AO PART A 1826 (here ammonium, NH₄⁺) transfers from the split cell anode chamber 1832 to the cathode chamber 1831 by passing through the membrane separator 1833 (here a permselective membrane supporting ion conduction and selective towards cation transport and retards transfer of catholyte solvent reduction product SRP 1824 back into the anolyte by passage through the membrane). Electrochemically cleaned anolyte of reduced OA concentration is passed out of the anode chamber 1832 as anolyte product solution 1826 and is combined with catholyte product solution 1828 and passed from the draw solution regeneration and removal unit 1820 as product water stream 1822. OA PART A 1826 passes to the catholyte chamber where it combines with the catholyte solvent reduction product SRP 1824 (hydroxide, OH⁻) generated by reduction of solvent CS 1840 (water) by reaction (8) at the cathode and separates OS PART A from the catholyte solvent by reaction (11) by creating ammonia gas (NH₃) which separates in conjunction with the product ammonia (NH₃) gas solubility. The outgassed product gas ammonia gas (NH₃) separates from the catholyte solvent CS 1840 and is removed from the cathode chamber 1831 as stream 1835. The ammonia gas (NH₃) 1835 is fed to reaction chamber 1851.

OSMOTIC AGENT PART B (CO₃⁻²) NEUTRALIZATION REACTIONS

2H⁺+CO₃⁻²→H₂CO₃(l) (9)

H₂CO₃(l)→H₂O(l)+CO₂(g) (10)

OSMOTIC AGENT PART A (NH₄⁺) NEUTRALIZATION REACTION

NH₄⁺+OH⁻→NH₃(g)+H₂O(l) (11)

OSMOTIC AGENT ([NH₄]₂CO₃) REGENERATION REACTION

NH₃(g)+CO₂(g)+nH₂O(l)→(NH₄)₂CO₃(aq) (12)

Through catholyte and anolyte recirculation and control of makeup water 1870 addition, the anolyte solution product 1803 can be concentrated in the target OA ([NH₄]₂CO₃). Some makeup OA AB 1825 may also be fed into reaction chamber 1851 to replenish any net loss of OA during this recycling process. The cleaned, refreshed draw solution 1803 concentrated in OA ([NH₄]₂CO₃) after the EC treatment gets returned to the FO unit of the STEP 1 to complete the recycle of the draw solution as part of the integrated two-step FO water treatment.

The preceding noted example may be applicable to a range of combinations of redox active cations used with appropriate anions. Notable common AO examples include but are not limited to: NH₄NO₂, [NH₄]₂SO₃, [NH₄]₂S, and others.

Yet another class of embodiments of processing devices in accordance with the present invention has been illustrated in FIG. 3. The devices of the illustrated embodiment have been arranged with the specific example of a two-step treatment scheme utilizing FO for the STEP 1 and EC cells for the STEP 2, as illustrated in FIG. 3. This particular embodiment of the two-step integrated FO and EC treatment of the present invention provides an example of a device suitable for use in the current method for illustrative purposes and may include for the STEP 1 a FO unit 300 into which a feed water stream 301 is fed for treatment along with a separate concentrated draw solution stream 303. Solvent (water) is separated by the FO unit and passed into the distinct draw stream, diluting it into used diluted draw solution 323 which exits the FO unit while the distinct treated FO reject solution stream 302 also exits the FO unit. The used diluted draw solution 323 is, for the STEP 2, transferred to an EC solvent separation and draw solution regeneration unit 320. The EC unit separates solvent (water) from the used diluted draw solution 323, creating a distinct TPW 322 stream and a distinct electrochemically separated osmotic agent PART A 324 which is introduced into the other half-cell of the EC unit to act as feedstock for generation of osmotic agent PART A while electrochemically separated osmotic agent PART B 326 is transferred from the diluted draw solution chamber to the electrochemically generated concentrated draw solution chamber across the chamber separation membrane. Osmotic agent PART A, electrolytically generated from stream 324 and osmotic agent PART B 326 combine to regenerate the electrochemically generated concentrated draw solution 303 which is returned to the FO unit of the STEP 1 to complete the recycle of the draw solution as part of the integrated two-step FO water treatment.

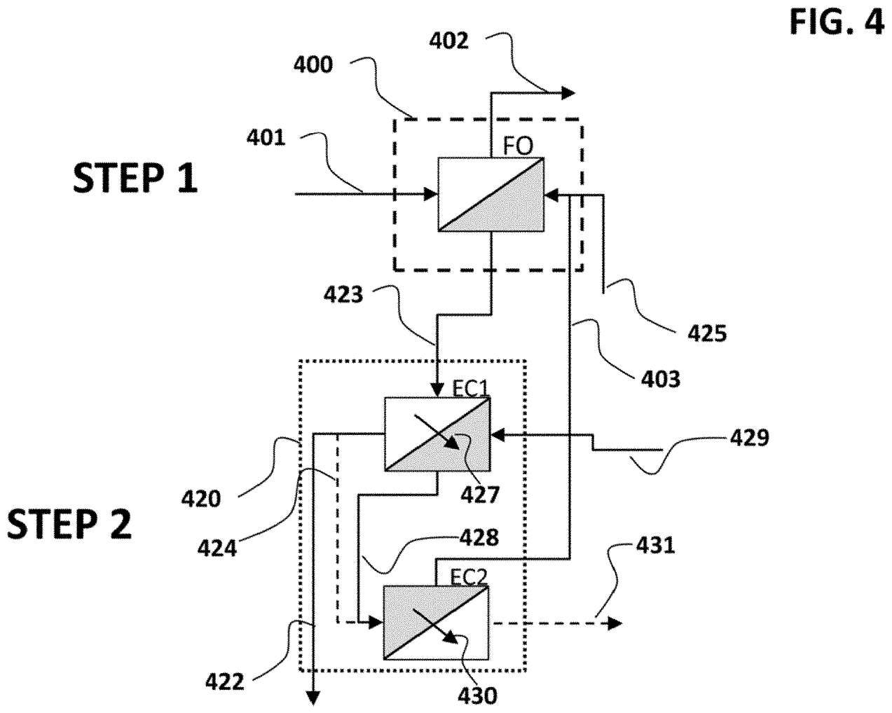

Yet another class of embodiments of processing devices for the present invention in accordance with the above treatment scheme has been illustrated in FIG. 4. The devices of the illustrated embodiment have been arranged with the specific example of a two-step treatment scheme utilizing FO for the STEP 1 and at least two electrochemical cells EC1 and EC2 used in conjunction for the STEP 2 as illustrated in FIG. 4 for the two electrolytic cell case. This one embodiment of a two-step integrated FO and EC treatment of the present invention provides a single nonexclusive example of a device suitable for use in the current method for illustrative purposes and may include for the STEP 1 FO unit 400 into which a feed water stream 401 is fed for treatment along with a separate concentrated draw solution stream 403 and as needed a osmotic agent makeup stream 425. Solvent (water) is separated by the FO unit and passed into the distinct draw stream, diluting it into used diluted draw solution 423 which exits the FO unit while the distinct treated FO reject solution stream 402 also exits the FO unit. The used diluted draw solution 423 is, for the STEP 2, transferred to one half-cell (here taken as the cathode chamber) of a first electrolytic cell EC1 of the solvent separation and draw solution regeneration unit 420. Unit EC1 separates solvent (water) from the used diluted draw solution 423, creating a distinct TPW stream 422 stream and a distinct electrochemically separated osmotic agent PART A 424. Concurrently for charge balance, osmotic agent PART B in stream 423 gets electrochemically separated and transferred across the separator membrane and into the anode chamber as the electrochemically separated osmotic agent PART B 427. The TPW stream 422 exits the solvent separation and draw solution regeneration unit 420 while the separated osmotic agent PART A 424 is passed to and fed into the complementary half-cell (opposite polarity, here taken as the anode chamber) portion of the at least one additional electrolytic cell EC2 to act as feedstock for generation of osmotic agent PART A. A second distinct stream of makeup feed for the EC1 anode generated osmotic agent PART B counter ion 429 is fed into the anode chamber of EC1. A stream 428 consisting of osmotic agent PART B 427 transferred across the EC1 separator membrane, makeup feed for the EC1 anode generated osmotic agent PART B counter ion 429 and anode generated osmotic agent PART B counter ion is passed to and fed into the analogous (same polarity, here taken as the anode chamber) portion of the at least one additional electrolytic cell EC2 where osmotic agent PART A from stream 424 is converted back to its original form and combines with osmotic agent PART B stream 428 as the EC1 (here anode) generated counter ion 430 concurrently gets electrochemically transferred across the selective chamber separation membrane of EC2 to regenerate the concentrated osmotic agent in the at least one concentrated draw solution stream 403, which gets returned to the FO unit of the STEP 1 for reuse to complete the recycle of the draw solution as part of the integrated two-step FO water treatment. Stream 431, the separable reduction product of the half-cell (here taken as the cathode chamber) of an at least one additional electrolytic cell EC2 exits the solvent separation and draw solution regeneration unit 420.

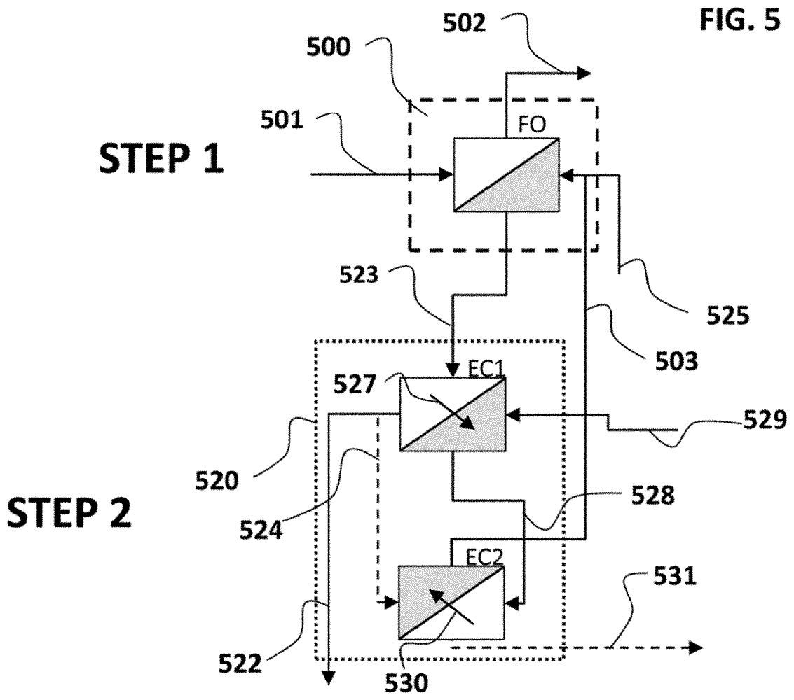

Yet another class of embodiments of processing devices for the present invention in accordance with the above treatment scheme has been illustrated in FIG. 5. The devices of the illustrated embodiment have been arranged with the specific example of a two-step treatment scheme utilizing FO for the STEP 1 and at least two cells EC1 and EC2 used in conjunction for the STEP 2 as illustrated in FIG. 5 for the two electrolytic cell case. This particular embodiment of a two-step integrated FO and EC treatment of the present invention provides a single, nonexclusive example of a device suitable for use in the current method for illustrative purposes and may include for the STEP 1 a FO unit 500 into which a feed water stream 501 is fed for treatment along with a separate concentrated draw solution stream 503 and as needed a osmotic agent makeup stream 525. Solvent (water) is separated by the FO unit and passed into the distinct refreshed draw stream (combined streams 503 and 525), diluting it into used diluted draw solution 523 which exits the FO unit while the distinct treated FO reject solution stream 502 also exits the FO unit. The used diluted draw solution 523 is, for the STEP 2, transferred to one half-cell (here taken as the cathode chamber) of a first electrolytic cell EC1 of the solvent separation and draw solution regeneration unit 520. Unit EC1 unit separates solvent (water) from the used diluted draw solution 523, creating a distinct TPW stream 522 stream and a distinct electrochemically separated osmotic agent PART A 524. Concurrently for charge balance, osmotic agent PART B in stream 523 gets electrochemically separated and transferred across the separator membrane into the anode chamber as the electrochemically separated osmotic agent PART B 527. The TPW stream 522 exits the solvent separation and draw solution regeneration unit 520 while the separated osmotic agent PART A 524 is passed to and fed into the complementary half-cell (opposite polarity, here taken as the anode chamber) portion of the at least one additional electrolytic cell EC2 to act as feedstock for generation of osmotic agent PART A. A second distinct stream of makeup feed for the EC1 anode generated osmotic agent PART B counter ion 529 is fed into the anode chamber of EC1. A stream 528 consisting of osmotic agent PART B 527 transferred across the EC1 separator membrane, makeup feed for the EC1 anode generated osmotic agent PART B counter ion 529 and anode generated osmotic agent PART B counter ion is passed to and fed into the complementary (opposite polarity, here taken as the cathode chamber) portion of the at least one additional electrolytic cell. EC2 where osmotic agent PART B counter ion from stream 528 is eliminated or converted back to its original form and osmotic agent PART B is electrochemically transferred across the EC2 chamber separator membrane into the opposite EC2 half-cell (here the anode chamber) as stream 530 where it combines with the EC2 anode regenerated osmotic agent PART A from feed stream 524. This regenerates the concentrated osmotic agent draw solution 503 in the EC2 anode chamber from which it gets returned to the FO unit of the STEP 1 for reuse to complete the recycle of the draw solution as part of the integrated two-step FO water treatment. Stream 531, the separable reduction product of the half-cell (here taken as the cathode chamber) of at least one additional electrolytic cell. EC2 exits the solvent separation and draw solution regeneration unit 520.

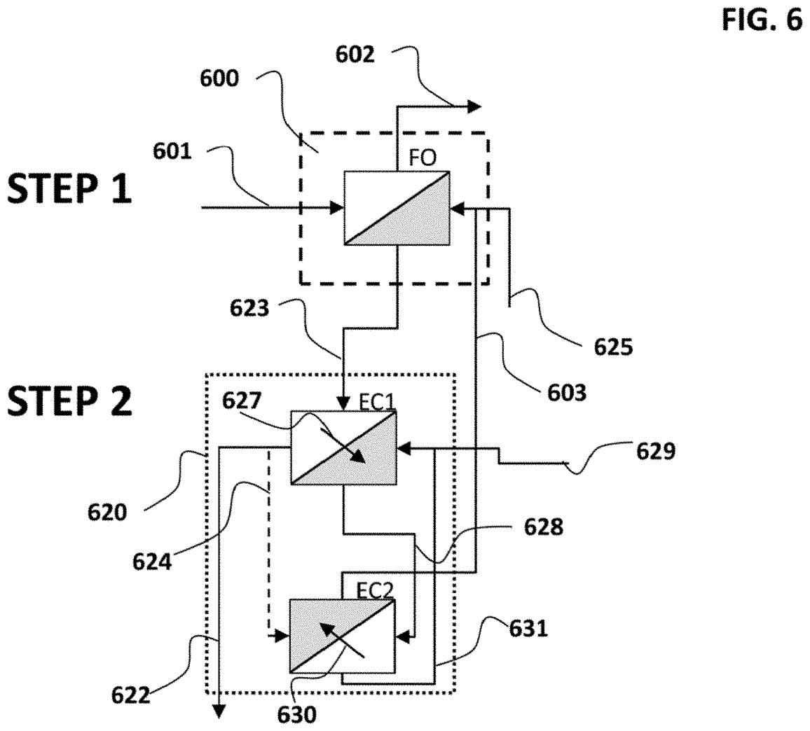

Yet another class of embodiments of processing devices for the present invention in accordance with the above treatment scheme has been illustrated in FIG. 6. The devices of the illustrated embodiment have been arranged with the specific example of a two-step treatment scheme utilizing FO for the STEP 1 and at least two EC cells used in conjunction for the STEP 2 as illustrated in FIG. 6 for the two electrolytic cell case. This one embodiment of a two-step integrated FO and EC treatment of the present invention provides a single, nonexclusive example of a device suitable for use in the current method for illustrative purposes and may include for the STEP 1 a FO unit 600 into which a feed water stream 601 is fed for treatment along with a separate concentrated draw solution stream 603 and as needed a osmotic agent makeup stream 625. Solvent (water) is separated by the FO unit and passed into the distinct draw stream, diluting it into used diluted draw solution 623 which exits the FO unit while the distinct treated FO reject solution stream 602 also exits the FO unit. The used diluted draw solution 623 is, for the STEP 2, transferred to one half-cell (here taken as the cathode chamber) of a first electrolytic cell EC1 of the solvent separation and draw solution regeneration unit 620. Unit EC1 unit separates solvent (water) from the used diluted draw solution 623, creating a distinct TPW stream 622 stream and a distinct electrochemically separated osmotic agent PART A 624. Concurrently for charge balance, osmotic agent PART B in stream 623 gets electrochemically separated and transferred across the separator membrane into the anode chamber as the electrochemically separated osmotic agent PART B 627. The TPW stream 622 exits the solvent separation and draw solution regeneration unit 620 while the separated osmotic agent PART A 624 is passed to and fed into the complementary half-cell (opposite polarity, here taken as the anode chamber) portion of the at least one additional electrolytic cell EC2 to act as feedstock for generation of osmotic agent PART A. A second distinct stream of makeup feed for the EC1 anode generated osmotic agent PART B counter ion 629 is fed into the anode chamber of EC1. A stream 628 consisting of osmotic agent PART B 627 transferred across the EC1 separator membrane, makeup feed for the EC1 anode generated osmotic agent PART B counter ion 629 and anode generated osmotic agent PART B counter ion is passed to and fed into the complementary (opposite polarity, here taken as the cathode chamber) portion of the at least one additional electrolytic cell EC2 where osmotic agent PART B counter ion from stream 628 is eliminated or converted back to its original form and osmotic agent PART B is electrochemically transferred across the EC2 chamber separator membrane into the opposite EC2 half-cell (here the anode chamber) as stream 630 where it combines with the EC2 anode regenerated osmotic agent PART A from feed stream 624. This regenerates the concentrated osmotic agent draw solution 603 in the EC2 anode chamber from which it gets returned to the FO unit of the STEP 1 for reuse to complete the recycle of the draw solution as part of the integrated two-step FO water treatment. Stream 631, the separable reduction product of the half-cell (here taken as the cathode chamber) of an at least one additional electrolytic cell EC2 is passed to the complementary (opposite polarity, here taken as the anode chamber) portion of the first electrolytic cell EC1 where it may act as a feedstock for the EC1 cathodic reaction like stream 629 or an additive to modify the stream 628 chemistry.

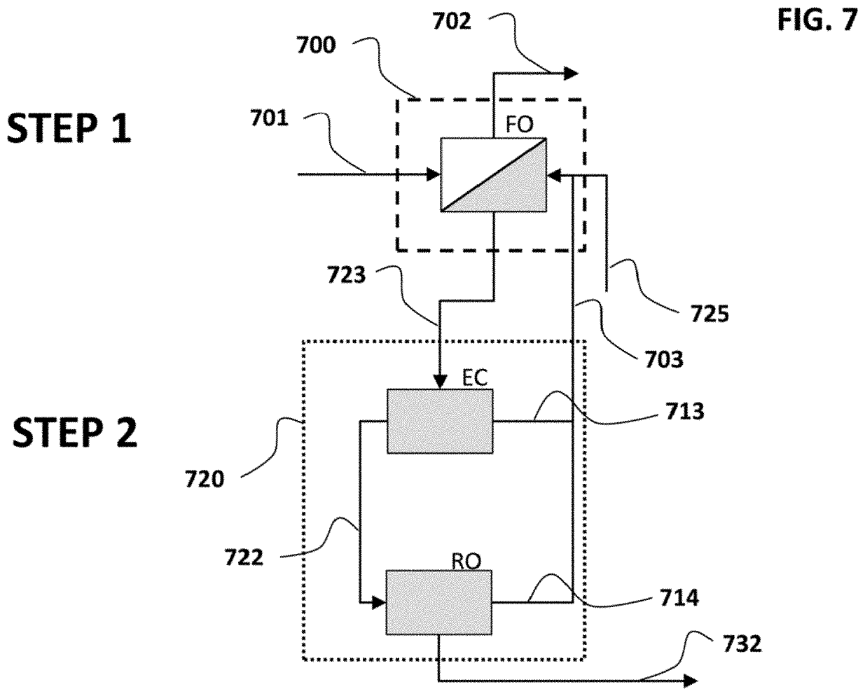

Yet another class of embodiments of processing devices for the present invention in accordance with the above treatment scheme has been illustrated in FIG. 7. The devices of the illustrated embodiment have been arranged with the specific example of a two-step treatment scheme utilizing FO for the STEP 1 and at least one EC cell and at least one RO unit (representing a common example of generalized conventional osmotic agent separation and regeneration methods) used in conjunction for the STEP 2 as illustrated in FIG. 7 for the combined electrochemical cell and conventional (RO) osmotic agent separation and regeneration system case. This one embodiment of a two-step integrated FO and EC treatment of the present invention provides a single, nonexclusive example of a device suitable for use in the current method for illustrative purposes and may include for the STEP 1 a FO unit 700 into which a feed water stream 701 is fed for treatment along with a separate concentrated draw solution stream 703 and as needed a osmotic agent makeup stream 725. Solvent (water) is separated by the FO unit and passed into the distinct draw stream, diluting it into used diluted draw solution 723 which exits the FO unit while the distinct treated FO reject solution stream 702 also exits the FO unit. The used diluted draw solution 723 is, for the STEP 2, transferred to the at least one electrolytic cell EC of the solvent separation and draw solution regeneration unit 720. It is noted that for clarity the at least one EC unit is shown in simplified form and represents the full range of possible variants for flow configurations as highlighted in FIG. 2 through FIG. 6. The STEP 2 EC unit separates solvent (water) from the used diluted draw solution 723, creating a distinct electrochemical treatment product water stream 722 and a distinct electrochemically concentrated osmotic agent stream 713. The electrochemical treatment product water stream 722 is passed to and feeds the RO unit where it is separated into a distinct Final Product Water (FPW) stream 732 which exits the solvent separation and draw solution regeneration unit 720. The remainder of the RO treated stream 722 is concentrated in osmotic agent present in stream 722 and exits the RO unit as a distinct reject or regenerated and concentrated draw solution 714 which is combined with electrochemically concentrated osmotic agent stream 713 and returned to the FO unit of the STEP 1 as the concentrated draw solution 703 to complete the recycle of the draw solution as part of the integrated two-step FO water treatment.

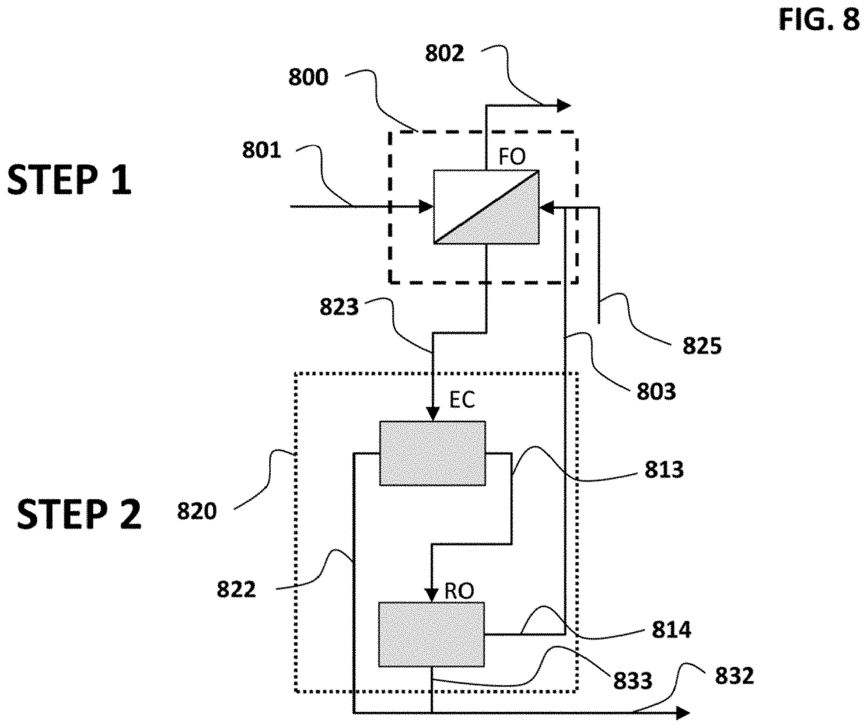

Yet another class of embodiments of processing devices for the present invention in accordance with the above treatment scheme has been illustrated in FIG. 8. The devices of the illustrated embodiment have been arranged with the specific example of a two-step treatment scheme utilizing FO for the STEP 1 and at least one EC cell and at least one RO unit (representing a common example of generalized conventional osmotic agent separation and regeneration methods) used in conjunction for the STEP 2 as illustrated in FIG. 8 for the combined electrochemical cell and conventional (RO) osmotic agent separation and regeneration system case. This one embodiment of a two-step integrated FO and EC treatment of the present invention provides a single, but nonexclusive example of a device suitable for use in the current method for illustrative purposes and may include for the STEP 1 a FO unit 800 into which a feed water stream 801 is fed for treatment along with a separate concentrated draw solution stream 803 and as needed a osmotic agent makeup stream 825. Solvent (water) is separated by the FO unit and passed into the distinct draw stream, diluting it into used diluted draw solution 823 which exits the FO unit while the distinct treated FO reject solution stream 802 also exits the FO unit. The used diluted draw solution 823 is, for the STEP 2, transferred to the at least one electrolytic cell EC of the solvent separation and draw solution regeneration unit 820. It is noted that for clarity the at least one EC unit is shown in simplified form and represents the full range of possible variants for flow configurations as highlighted in FIG. 2 through FIG. 6. The STEP 2 EC unit separates solvent (water) from the used diluted draw solution 823, creating a distinct electrochemical treatment product water stream 822 and a distinct electrochemically concentrated osmotic agent stream 813. The electrochemical treatment product water stream 822 exits the solvent separation and draw solution regeneration unit 820. The electrochemically concentrated osmotic agent stream 813 is passed to and feeds the RO unit where it is separated into a distinct RO Product Water (RO-PW) stream 833 and a distinct reject or regenerated and concentrated draw solution 814. RO-PW stream 833 exits the solvent separation and draw solution regeneration unit 820 and is combined with electrochemical treatment water stream 822 to create FPW stream 832 which exits the treatment system. The reject or regenerated and concentrated draw solution 814 from the RO element exits the solvent separation and draw solution regeneration unit 820 as the concentrated draw solution stream 803 which is combined with the osmotic agent makeup stream 825 to and returned to the FO unit of the STEP 1 as the concentrated draw solution 803 to complete the recycle of the draw solution as part of the integrated two-step FO water treatment.

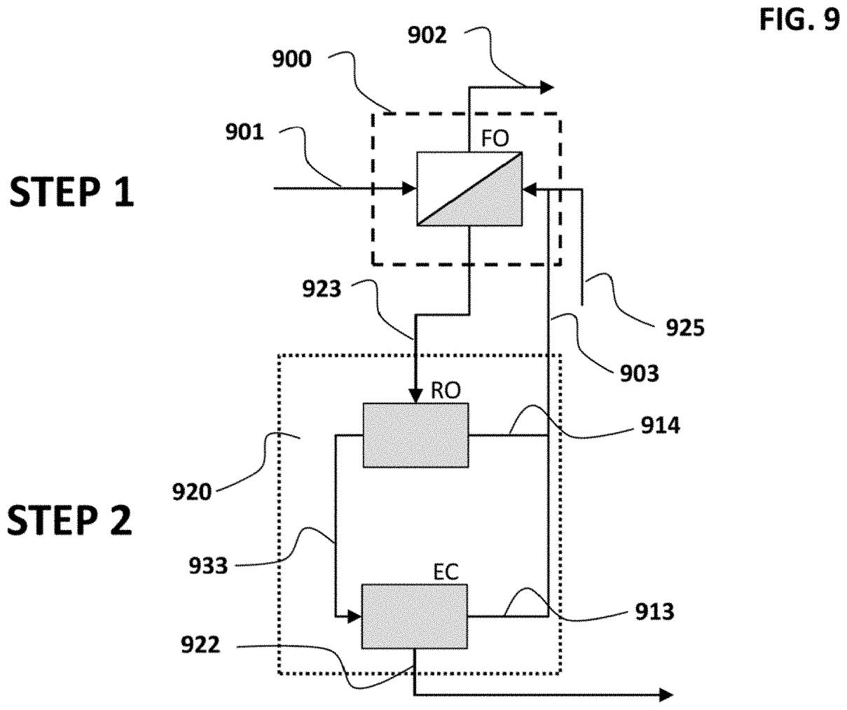

Yet another class of embodiments of processing devices for the present invention in accordance with the above treatment scheme has been illustrated in FIG. 9. The devices of the illustrated embodiment have been arranged with the specific example of a two-step treatment scheme utilizing FO for the STEP 1 and at least one EC cell and at least one RO unit (representing a common example of generalized conventional osmotic agent separation and regeneration methods) used in conjunction for the STEP 2 as illustrated in FIG. 9 for the combined electrochemical cell. and conventional (RO) osmotic agent separation and regeneration system case. This one embodiment of a two-step integrated FO and EC treatment of the present invention provides a single, nonexclusive example of a device suitable for use in the current method for illustrative purposes and may include for the STEP 1 a FO unit 900 into which a feed water stream 901 is fed for treatment along with a separate concentrated draw solution stream 903 and as needed a osmotic agent makeup stream 925. Solvent (water) is separated by the FO unit and passed into the distinct draw stream, diluting it into used diluted draw solution 923 which exits the FO unit while the distinct treated FO reject solution stream 902 also exits the FO unit. The undiluted draw solution 923 is, for STEP 2, transferred to the at least one RO unit of the solvent separation and draw solution regeneration unit 920. The STEP 2 RO unit separates solvent (water) from the used diluted draw solution 923, creating a distinct RO treatment product water stream 933 and a distinct reject or regenerated and concentrated draw solution 914. Stream 914 is concentrated in osmotic agent present in stream 923 and exits the RO unit as a distinct reject or regenerated and concentrated draw solution 914 which is combined with electrochemically concentrated osmotic agent stream 913. The RO product water stream 933 is passed to and feeds the EC where it is separated into a distinct electrochemical treatment water stream 922 which exits the solvent separation and draw solution regeneration unit 920 as the FPW stream. It is noted that for clarity the at least one EC unit is shown in simplified form and represents the full range of possible variants for flow configurations as highlighted in FIG. 2 through FIG. 6. The EC treatment of feed stream 933 also generates the distinct electrochemically concentrated osmotic agent stream 913. The electrochemically concentrated osmotic agent stream 913 and the RO regenerated and concentrated draw solution 914 are combined into concentrated draw solution stream 903 which exits the solvent separation and draw solution regeneration unit 920 and returns to the FO unit of the STEP 1 as the concentrated draw solution 903 to complete the recycle of the draw solution as part of the integrated two-step FO water treatment.

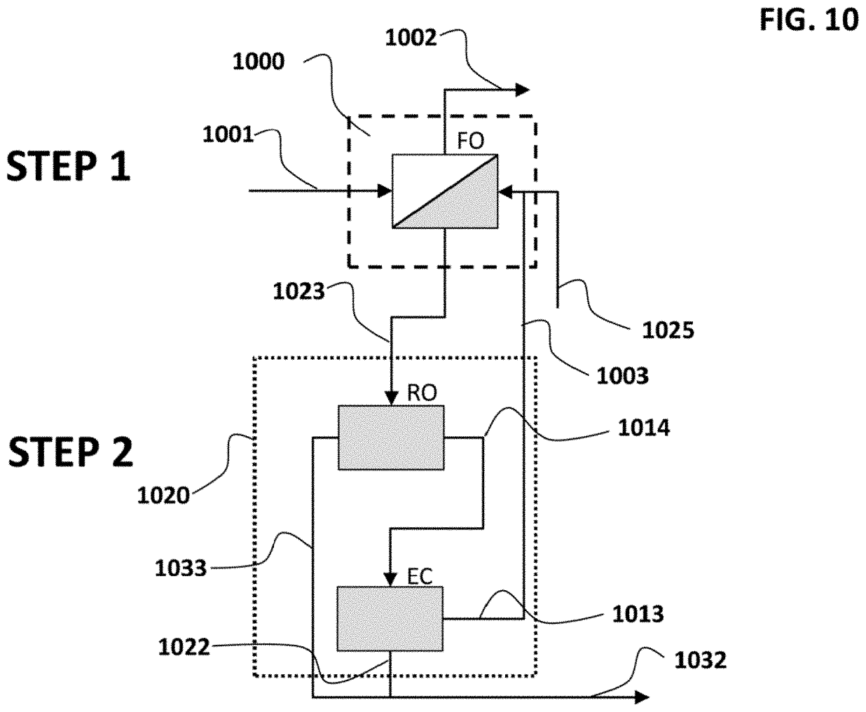

Yet another class of embodiments of processing devices for the present invention in accordance with the above treatment scheme has been illustrated in FIG. 10. The devices of the illustrated embodiment have been arranged with the specific example of a two-step treatment scheme utilizing FO for the STEP 1 and at least one EC cell and at least one RO unit (representing a common example of generalized conventional osmotic agent separation and regeneration methods) used in conjunction for the STEP 2 as illustrated in FIG. 10 for the combined electrochemical cell and conventional RO osmotic agent separation and regeneration system case. This one embodiment of a two-step integrated FO and EC treatment of the present invention provides a single, nonexclusive example of a device suitable for use in the current method for illustrative purposes and may include for the STEP 1 a FO unit 1000 into which a feed water stream 1001 is fed for treatment along with a separate concentrated draw solution stream 1003 and as needed a osmotic agent makeup stream 1025. Solvent (water) is separated by the FO unit and passed into the distinct draw stream, diluting it into used diluted draw solution 1023 which exits the FO unit while the distinct treated FO reject solution stream 1002 also exits the FO unit. The used diluted draw solution 1023 is, for the STEP 2, transferred to the at least one RO unit of the solvent separation and draw solution regeneration unit 1020. The STEP 2 RO unit separates solvent (water) from the used diluted draw solution 1023, creating a distinct RO_treatment product water stream 1033 which exits the solvent separation and draw solution regeneration unit 1020 and a distinct reject or regenerated and concentrated draw solution 1014. Stream 1014 is concentrated in osmotic agent present in stream 1023 and is passed to and feeds the at least one electrochemical element EC. The at least one electrochemical element EC feed 1014 is separated into a distinct electrochemical treatment water stream 1022 which is contains a lowered level of osmotic agent and exits the solvent separation and draw solution regeneration unit 1020 and electrochemically concentrated osmotic agent stream 1013. The RO treatment product water stream 1033 and the electrochemical treatment water stream 1022 exit the solvent separation and draw solution regeneration unit 1020 and are combined into as FPW stream 1032. The electrochemically concentrated osmotic agent stream 1013 exits the solvent separation and draw solution regeneration unit 1020 and returns to the FO unit of the STEP 1 as the concentrated draw solution 1003 to complete the recycle of the draw solution as part of the integrated two-step FO water treatment. It is noted that for clarity the at least one EC unit is shown in simplified form and represents the full range of possible variants for flow configurations as highlighted in FIG. 2 through FIG. 6.

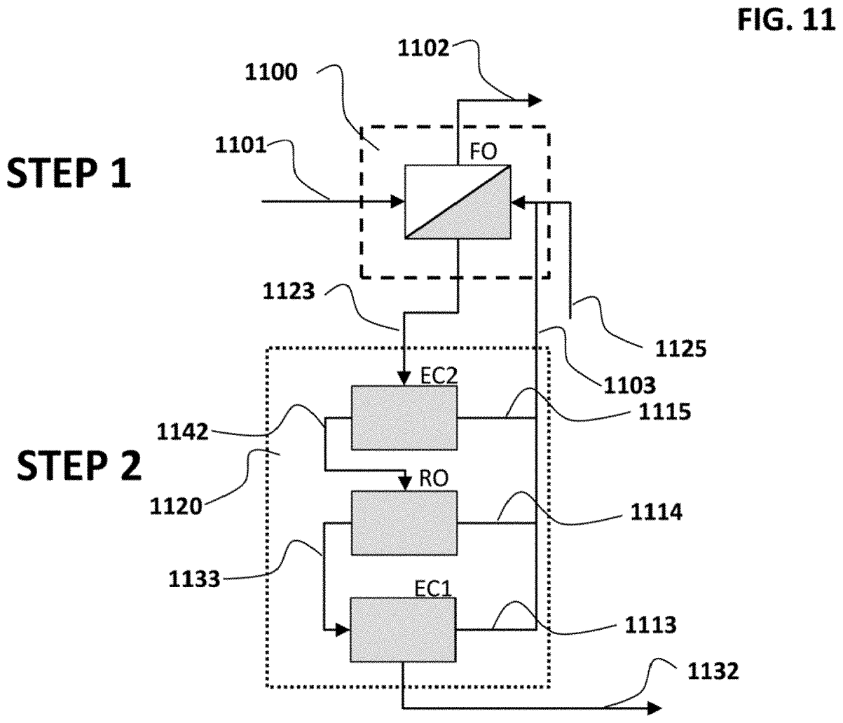

Yet another class of embodiments of processing devices for the present invention in accordance with the above treatment scheme has been illustrated in FIG. 11. The devices of the illustrated embodiment have been arranged with the specific example of a two-step treatment scheme utilizing FO for the STEP 1 and at least two electrochemical cells: first electrochemical cell EC1 and second electrochemical cell EC2 and at least one RO unit (representing a common example of generalized conventional osmotic agent separation and regeneration methods) used in conjunction for the STEP 2 as illustrated in FIG. 11 for the combined electrochemical cell and conventional RO osmotic agent separation and regeneration system case. This one embodiment of a two-step integrated FO and EC treatment of the present invention provides a single, nonexclusive example of a device suitable for use in the current method for illustrative purposes and may include for the STEP 1 a FO unit 1100 into which a feed water stream 1101 is fed for treatment along with a separate concentrated draw solution stream 1103 and as needed a osmotic agent makeup stream 1125. Solvent (water) is separated by the FO unit and passed into the distinct draw stream, diluting it into used diluted draw solution 1123 which exits the FO unit while the distinct treated FO reject solution stream 1102 also exits the FO unit. The used diluted draw solution 1123 is, for STEP 2, transferred to and fed into electrochemical cell EC2 of the solvent separation and draw solution regeneration unit 1120 where it gets separated into distinct stream EC2 treated product water 1142 and EC2 electrochemically concentrated draw solution 1115 which gets combined with streams 1114 and 1113 to form concentrated draw solution stream 1103 which exits solvent separation and draw solution regeneration unit 1120 and is returned to the STEP 1 FO unit 1100 for draw solution recycle as part of the integrated two-step FO water treatment. The EC2 treated product water 1142 is transferred to and fed into the at least one RO unit. The STEP 2 RO unit separates solvent (water) from the EC2 treated product water 1142, creating a distinct RO treatment product water stream 1133 and a distinct reject or regenerated and concentrated draw solution 1114. Stream 1114 is concentrated in osmotic agent present in stream 1142 and exits the RO unit as a distinct reject or regenerated and concentrated draw solution 1114. The RO product water stream 1133 is passed to and feeds the electrolytic cell EC1 where it is separated into a distinct EC1_electrochemical treatment water stream which exits the solvent separation and draw solution regeneration unit 1120 as FPW stream 1132. It is noted that for clarity that the at least two electrochemical units EC1 and EC2 are shown in simplified form and represent the full range of possible variants for flow configurations as highlighted in FIG. 2 through FIG. 6. The EC1 treatment of feed stream 1133 also generates the distinct electrochemically concentrated osmotic agent stream 1113.

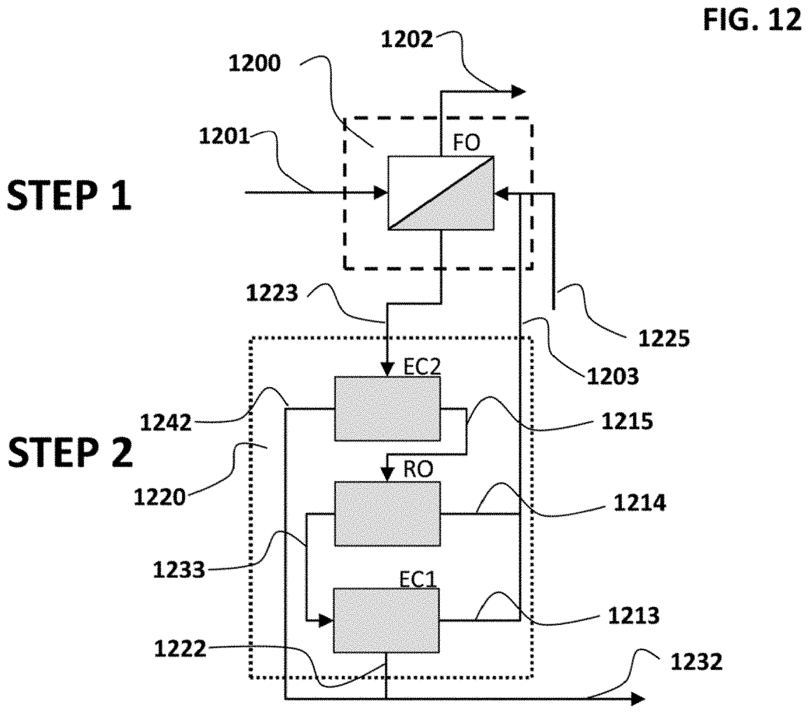

Yet another class of embodiments of processing devices for the present invention in accordance with the above treatment scheme has been illustrated in FIG. 12. The devices of the illustrated embodiment have been arranged with the specific example of a two-step treatment scheme utilizing FO for the STEP 1 and at least two electrochemical cells: first electrochemical cell EC1 and second electrochemical cell EC2 and at least one RO unit (representing a common example of generalized conventional osmotic agent separation and regeneration methods) used in conjunction for the STEP 2 as illustrated in FIG. 12 for the combined electrochemical cell and conventional RO osmotic agent separation and regeneration system case. This one embodiment of a two-step integrated FO and EC treatment of the present invention provides a single, nonexclusive example of a device suitable for use in the current method for illustrative purposes and may include for the STEP 1 a FO unit 1200 into which a feed water stream 1201 is fed for treatment along with a separate concentrated draw solution stream 1203 and as needed a osmotic agent makeup stream 1225. Solvent (water) is separated by the FO unit 1200 and passed into the distinct draw stream, diluting it into used diluted draw solution 1223 which exits the FO unit 1200 while the distinct treated FO reject solution stream 1202 also exits the FO unit 1200. The used diluted draw solution 1223 is, for the STEP 2, transferred to and fed into electrochemical cell EC2 of the solvent separation and draw solution regeneration unit 1220 where it gets separated into distinct stream EC2 treated product water 1242 and EC2 electrochemically concentrated draw solution 1215 which is transferred to and fed into the at least one RO unit. Stream EC2 treated product water 1242 exits solvent separation and draw solution regeneration unit 1220. The STEP 2 RO unit separates solvent (water) from the EC2 electrochemically concentrated draw solution 1215, creating a distinct RO treatment product water stream 1233 and a distinct reject or regenerated and concentrated draw solution 1214. Stream 1214 is concentrated in osmotic agent present in stream 1215 and exits the RO unit as a distinct reject or regenerated and concentrated draw solution 1214. The RO product water stream 1233 is passed to and feeds the electrolytic cell EC1 where it is separated into a distinct EC1 electrochemical treatment water stream 1222 which exits the solvent separation and draw solution regeneration unit 1220 and is combined with EC2 treated product water 1242 to form FPW stream 1232. Electrochemical unit EC1 also produces distinct stream EC electrochemically concentrated draw solution 1213. Stream 1213 is concentrated in osmotic agent present in stream 1233 and gets combined with stream 1214 to form concentrated draw solution stream 1203 which exits solvent separation and draw solution regeneration unit 1220 and is returned to the STEP 1 FO unit 1200 for draw solution recycle as part of the integrated two-step FO water treatment. It is noted that for clarity the at least two electrochemical units EC1 and EC2 are shown in simplified form and represent the full range of possible variants for flow configurations as highlighted in FIG. 2 through FIG. 6.

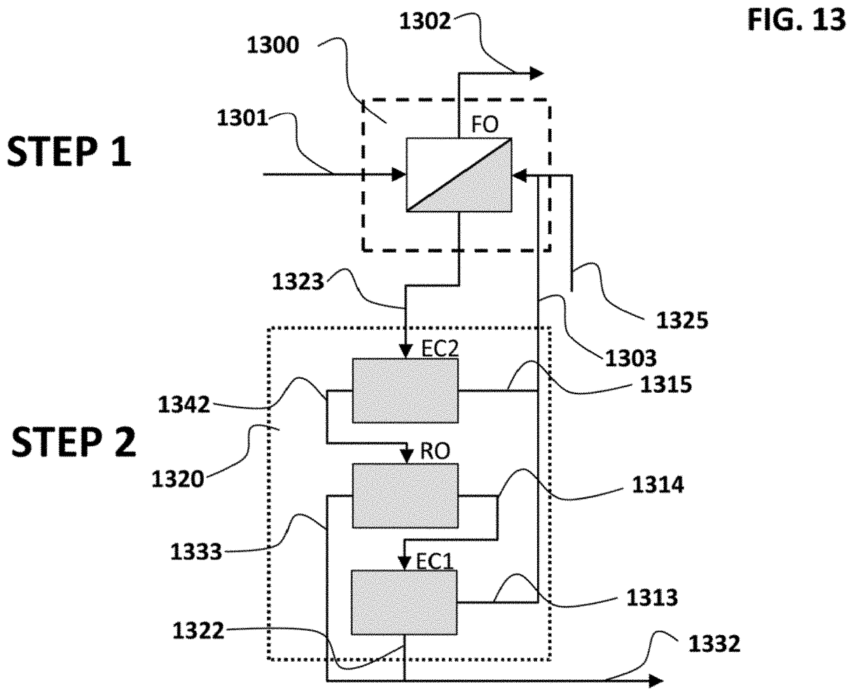

Yet another class of embodiments of processing devices for the present invention in accordance with the above treatment scheme has been illustrated in FIG. 13. The devices of the illustrated embodiment have been arranged with the specific example of a two-step treatment scheme utilizing FO for the STEP 1. and at least two electrochemical cells: first electrochemical cell EC1 and second electrochemical cell EC2 and at least one RO unit (representing a common example of generalized conventional osmotic agent separation and regeneration methods) used in conjunction for the STEP 2 as illustrated in FIG. 13 for the combined electrochemical cell and conventional RO osmotic agent separation and regeneration system case. This one embodiment of a two-step integrated FO and EC treatment of the present invention provides a single, nonexclusive example of a device suitable for use in the current method for illustrative purposes and may include for the STEP 1 a FO unit 1300 into which a feed water stream 1301 is fed for treatment along with a separate concentrated draw solution stream 1303 and as needed a osmotic agent makeup stream 1325. Solvent (water) is separated by the FO unit and passed into the distinct draw stream, diluting it into used diluted draw solution 1323 which exits the FO unit while the distinct treated FO reject solution stream 1302 also exits the FO unit. The used diluted draw solution 1323 is, for the STEP 2, transferred to and fed into electrochemical cell EC2 of the solvent separation and draw solution regeneration unit 1320 where it gets separated into distinct stream EC2 treated product water 1342 and EC2 electrochemically concentrated draw solution 1315 which exits solvent separation and draw solution regeneration unit 1320. Stream EC2 treated product water 1342 is transferred to and fed into the at least one RO unit. The STEP 2 RO unit separates solvent (water) from the EC2 treated product water 1342, creating a distinct RO treatment product water stream 1333 and a distinct reject or regenerated and concentrated draw solution 1314. Stream 1333 exits the solvent separation and draw solution regeneration unit 1320. Stream 1314 is concentrated in osmotic agent present in stream 1342 and is passed to and feeds the electrolytic cell EC1 where it is separated into a distinct EC1 electrochemical treatment water stream 1322 and distinct stream EC1 electrochemically concentrated draw solution 1313. Stream 1313 is concentrated in osmotic agent present in stream 1314 and gets combined with EC2 electrochemically concentrated draw solution 1315 and exits the solvent separation and draw solution regeneration unit 1320 as concentrated draw solution stream 1303 and is returned to the STEP 1 FO unit 1300 for draw solution recycle as part of the integrated two-step FO water treatment. Unit EC1 electrochemical treatment water stream 1322 exits the solvent separation and draw solution regeneration unit 1320 and is combined with RO product water stream 1333 to form FPW stream 1332. It is noted that for clarity the at least two electrochemical units EC1 and EC2 are shown in simplified form and represent the full range of possible variants for flow configurations as highlighted in FIG. 2 through FIG. 6.

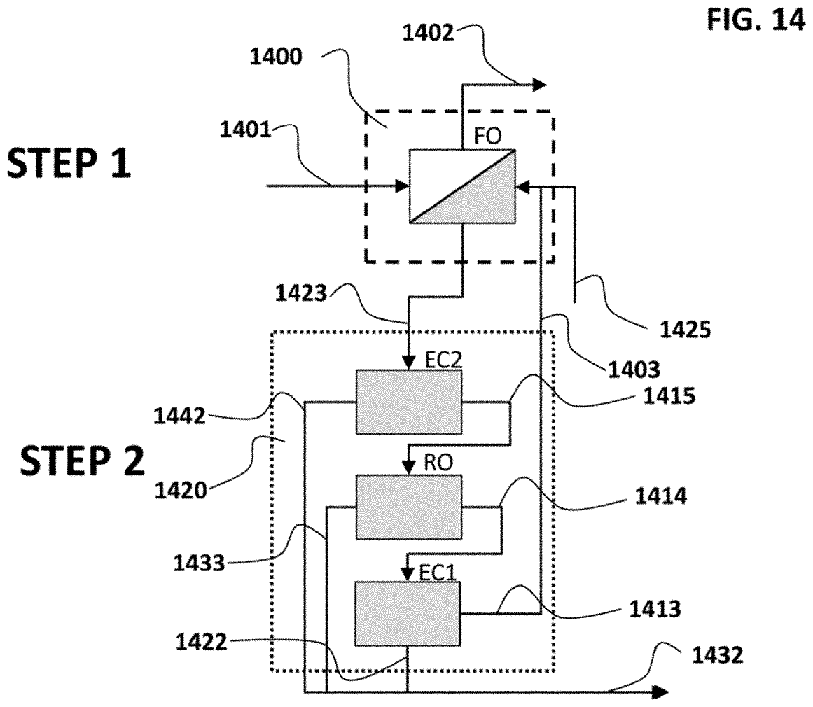

Yet another class of embodiments of processing devices for the present invention in accordance with the above treatment scheme has been illustrated in FIG. 14. The devices of the illustrated embodiment have been arranged with the specific example of a two-step treatment scheme utilizing FO for the STEP 1 and at least two electrochemical cells: first electrochemical cell EC1 and second electrochemical cell EC2 and at least one RO unit (representing a common example of generalized conventional osmotic agent separation and regeneration methods) used in conjunction for the STEP 2 as illustrated in FIG. 14 for the combined electrochemical cell and conventional. RO osmotic agent separation and regeneration system case. This one embodiment of a two-step integrated FO and EC treatment of the present invention provides a single, nonexclusive example of a device suitable for use in the current method for illustrative purposes and may include for the STEP 1 a FO unit 1400 into which a feed water stream 1401 is fed for treatment along with a separate concentrated draw solution stream 1403 and as needed a osmotic agent makeup stream 1425. Solvent (water) is separated by the FO unit and passed into the distinct draw stream, diluting it into used diluted draw solution 1423 which exits the FO unit while the distinct treated FO reject solution stream 1402 also exits the FO unit 1400. The used diluted draw solution 1423 is, for the STEP 2, transferred to and fed into electrochemical cell. EC2 of the solvent separation and draw solution regeneration unit 1420 where it gets separated into distinct stream EC2 treated product water 1442 which exits solvent separation and draw solution regeneration unit 1420 and EC2 electrochemically concentrated draw solution 1415 which is transferred to and fed into the at least one RO unit. The STEP 2 RO unit separates solvent (water) from the EC2 electrochemically concentrated draw solution 1415, creating a distinct RO treatment product water stream 1433 and a distinct reject or regenerated and concentrated draw solution 1414. Stream 1433 exits the solvent separation and draw solution regeneration unit 1420. Stream 1414 is concentrated in osmotic agent present in stream 1415 and is passed to and feeds the electrolytic cell EC1 where it is separated into a distinct EC1 electrochemical treatment water stream 1422 and distinct stream EC1 electrochemically concentrated draw solution 1413. Stream 1413 is concentrated in osmotic agent present in stream 1414 and exits the solvent separation and draw solution regeneration unit 1420 as concentrated draw solution stream 1403 and is returned to the STEP 1 FO unit 1400 for draw solution recycle as part of the integrated two-step FO water treatment. Unit EC1 electrochemical treatment water stream 1422 exits the solvent separation and draw solution regeneration unit 1420 and is combined with RO product water stream 1433 and EC2 treated product water stream 1442 to form the FPW stream 1432. It is noted that for clarity the at least two electrochemical units EC1 and EC2 are shown in simplified form and represent the full range of possible variants for flow configurations as highlighted in FIG. 2 through FIG. 6.

A multitude of potential redox based chemistries may be structured as separate embodiments or in combinations to achieve targeted treatment. An exemplary subset may include conversions based on electrolytically driven pH shifts used to drive osmotic agent transformations or direct electrolytic separations or generations such as gas formation or plating/electrocorrosion where the target species and metals can be selected to achieve a combination of tailored solution constituent redox state and solution pH generated as a result of the electrochemical treatment.

In addition, a variety (or mixture) of acids or bases as osmotic agents could be generated and removed in different embodiments. Embodiments generating sulfuric acid may be of particular interest since the raw target stream sources including sulfate may be very common. Also, embodiments including seawater application as the raw target stream (which the mining industry may be increasingly utilizing) may generate HCl— should that be of interest.

The present invention has been described with references to the exemplary embodiments arranged for different applications. While specific values, relationships, materials and components have been set forth for purposes of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

I claim:

1. A device for controlling acidity of electrolytes and the oxidation states or concentrations of selected constituents for treatment of liquid media using electricity for electrochemical separation and regeneration of forward osmosis draw solutions comprising:
at least one FO unit arranged for osmotic solvent separation from at least one feed water stream;
and at least one electrochemical solvent separation and draw solution regeneration unit incorporating at least one electrochemical cell, having at least one concentrated draw solution half-cell and at least one another half-cell, arranged to use at least one diluted draw solution to generate at least one concentrated draw solution, at least one TPW stream and at least one osmotic agent;
wherein, the at least one concentrated draw solution have been arranged to reenter the at least one forward osmosis unit.

2. The device of claim 1, wherein the at least one electrochemical solvent separation and draw solution regeneration unit incorporates at least one additional electrolytic cell arranged to regenerate and separate the at least one osmotic agent in the at least one concentrated draw solution.

3. The device of claim 2, wherein the at least one additional electrolytic cell arranged to regenerate the at least one osmotic agent in the at least one concentrated draw solution has been polarized with opposite polarity relative to the at least one electrochemical cell having at least one concentrated draw solution half-cell and at least one another half-cell separated by a separator membrane, and set to eliminate or convert back to its original state the osmotic agent in conjunction with species crossing the separator membrane.

4. The device of claim 1, wherein the at least one electrochemical solvent separation and draw solution regeneration unit incorporates at least one additional RO unit arranged to regenerate and separate the at least one osmotic agent in the at least one concentrated draw solution.

5. The device of claim 4, wherein the at least one additional RO unit has been arranged to receive and treat at least one electrochemically concentrated osmotic agent stream separating at least one RO-PW stream from the at least one concentrated draw solution.

6. The device of claim 4, wherein the at least one additional RO unit has been arranged to receive and treat at least one treated product water, regenerate at least one concentrated draw solution, and separate at least one RO treatment product water stream.

7. The device of claim 6, wherein the at least one additional RO unit has been arranged to supply the at least one RO treatment product water stream to the least one electrolytic cell.

8. The device of claim 6, wherein the at least one additional RO unit has been arranged to separate the at least one RO treatment product water stream which exits the solvent separation and draw solution regeneration unit.

9. A method for controlling acidity of electrolytes and the oxidation states or concentrations of selected constituents for treatment of liquid media using electricity for electrochemical separation and regeneration of forward osmosis draw solutions comprising:
Providing at least one reactor device having at least one FO unit and at least one electrochemical solvent separation and draw solution regeneration unit incorporating at least one electrochemical cell having at least one concentrated draw solution half-cell and at least one another half-cell;
STEP 1, feeding at least one feed water stream and the at least one concentrated draw solution into the at least one FO unit and separating at least one FO reject solution stream from at least one distinct draw stream which, diluted into at least one used diluted draw solution which exits the at least one forward osmosis unit, while at least one FO reject solution stream separately exits the at least one forward osmosis unit;
STEP 2, feeding the at least one used diluted draw solution into the at least one concentrated draw solution half-cell and feeding at least one stream of feed stock into the at least one another half-cell; separating solvent from the at least one used diluted draw solution, electrochemically regenerating at least one concentrated OA draw solution and separating it from at least one TPW stream; returning the at least one concentrated OA draw into the at least one FO unit.

10. The method for controlling acidity of electrolytes and the oxidation states or concentrations of selected constituents for treatment of liquid media using electricity for electrochemical separation and regeneration of forward osmosis draw solutions of claim 9, wherein the at least one concentrated OA draw has been separated into at least one electrochemically separated osmotic agent PART A, and at least one electrochemically separated osmotic agent PART B.

11. The method for controlling acidity of electrolytes and the oxidation states or concentrations of selected constituents for treatment of liquid media using electricity for electrochemical separation and regeneration of forward osmosis draw solutions of claim 10, wherein the at least one osmotic agent PART A is electrochemically separated from the at least one draw solution while the at least one osmotic agent PART B gets transferred into the at least one another half-cell.

12. The method for controlling acidity of electrolytes and the oxidation states or concentrations of selected constituents for treatment of liquid media using electricity for electrochemical separation and regeneration of forward osmosis draw solutions of claim 10, wherein the at least one osmotic agent PART B is electrochemically separated from the at least one draw solution while the at least one osmotic agent PART A get transferred into the at least one another half-cell.

13. The method for controlling acidity of electrolytes and the oxidation states or concentrations of selected constituents for treatment of liquid media using electricity for electrochemical separation and regeneration of forward osmosis draw solutions of claim 9, wherein the at least one concentrated OA draw includes compounds chosen from the group of compounds consisting of carbonate salts, hydroxyl complexes for transition metals, ammonia complexes, Cu(NO₃)₂, Cu(ClO₄)₂, Fe(NO₃)₂, Fe(ClO₄)₂, FeSO₄, Fe(NO₃)₃, Fe(ClO₄)₃, Fe₂(SO₄)₃Cu(NO₃), Cu(ClO₄), Zn(NO₃)₂, Zn(ClO₄)₂, ZnSO₄, KOH, LiOH, NH₄OH, Mg(OH)₂, (Fe—OH)⁺², [Fe—(OH)₂]⁺¹, Cu(NH3)₄⁺².

14. The method for controlling acidity of electrolytes and the oxidation states or concentrations of selected constituents for treatment of liquid media using electricity for electrochemical separation and regeneration of forward osmosis draw solutions of claim 9 comprising, in addition, providing at least one additional electrolytic cell arranged to regenerate and separate the at least one osmotic agent in the at least one concentrated draw solution.

15. The method for controlling acidity of electrolytes and the oxidation states or concentrations of selected constituents for treatment of liquid media using electricity for electrochemical separation and regeneration of forward osmosis draw solutions of claim 14, wherein the at least one additional electrolytic cell arranged to regenerate the at least one osmotic agent in the at least one concentrated draw solution has been polarized with opposite polarity relative to the at least one electrochemical cell having at least one concentrated draw solution half-cell and at least one another half-cell separated by a separator membrane, and set to eliminate or convert back to its original state the osmotic agent in conjunction with species crossing the separator membrane.

16. The method for controlling acidity of electrolytes and the oxidation states or concentrations of selected constituents for treatment of liquid media using electricity for electrochemical separation and regeneration of forward osmosis draw solutions of claim 9 comprising, in addition, application of an electrochemical solvent separation and draw solution regeneration unit incorporating at least one additional RO unit arranged to regenerate and separate the at least one osmotic agent in the at least one concentrated draw solution.

17. The method for controlling acidity of electrolytes and the oxidation states or concentrations of selected constituents for treatment of liquid media using electricity for electrochemical separation and regeneration of forward osmosis draw solutions of claim 16, wherein the at least one additional RO unit has been arranged to receive and treat at least one electrochemically concentrated osmotic agent stream separating at least one RO-PW stream from the at least one concentrated draw solution.

18. The method for controlling acidity of electrolytes and the oxidation states or concentrations of selected constituents for treatment of liquid media using electricity for electrochemical separation and regeneration of forward osmosis draw solutions of claim 16, wherein the at least one additional RO unit has been arranged to receive and treat at least one treated product water, regenerate at least one concentrated draw solution, and separate at least one RO treatment product water stream.

19. The method for controlling acidity of electrolytes and the oxidation states or concentrations of selected constituents for treatment of liquid media using electricity for electrochemical separation and regeneration of forward osmosis draw solutions of claim 16, wherein the at least one additional RO unit has been arranged to supply the at least one RO treatment product water stream to the least one electrolytic cell.

20. The method for controlling acidity of electrolytes and the oxidation states or concentrations of selected constituents for treatment of liquid media using electricity for electrochemical separation and regeneration of forward osmosis draw solutions of claim 16, wherein the at least one additional RO unit has been arranged to separate the at least one RO treatment product water stream which exits the solvent separation and draw solution regeneration unit.
